(19) United States
(12) Patent Application Publication
(10) Pub. No.: US 2024/0289621 A1
(43) Pub. Date: Aug. 29, 2024

(54) NEURAL NETWORK MODEL CONVERSION DEVICE AND METHOD

(71) Applicant: NEC Corporation, Minato-ku, Tokyo (JP)

(72) Inventor: Seiya Shibata, Tokyo (JP)

(73) Assignee: NEC Corporation, Minato-ku, Tokyo (JP)

(21) Appl. No.: 18/568,876

(22) PCT Filed: Jun. 15, 2021
(86) PCT No.: PCT/JP2021/022649

§ 371 Date: Dec. 11, 2023

(51) Int. Cl. G06N 3/082

(52) U.S. Cl. CPC G06N 3/082

(57) ABSTRACT

The division position determination unit determines a division position in a weight value group, which is a weight value group of at least one layer included in a given neural network model, and has a configuration kernels are arranged in a kernel direction, each of which is obtained by arranging at least one or more weight values in a channel direction. The division unit obtains multiple weight value groups by dividing the weight value group at the division position. The connection layer addition unit adds a connection layer that is a layer that connects respective output data obtained by calculating input data to the layer and respective weight value groups after division to make one output data.

### TECHNICAL FIELD

The present invention relates to a neural network model conversion device, a neural network model conversion method, and a computer-readable recording medium in which a neural network model conversion program is recorded, for converting a neural network model.

### BACKGROUND ART

A neural network model learned by deep learning may be used to predict about predetermined matters.

A neural network model includes multiple layers. Input data is given to one layer, output data of that layer is calculated by operations, and the output data becomes the input data for the next layer. The final data obtained in the last layer represents the prediction result. A weight value group (multiple weight values) is also associated with a layer.

The presence of 0 as a weight value in a weight value group is called weight sparsity. How many weight values “0” are included in a weight value group is referred to as sparsity. Specifically, the sparsity indicates a ratio of the number of weight values that are 0 to the number of weight values in the weight value group. For example, when the weight value “0” is not included in the weight value group, the sparsity is 0%. When all the weight values in the weight value group are “0”, the sparsity is 100%.

In addition, PTL 1 describes sorting weight values.

In addition, PTL 2 describes removal of neurons.

### CITATION LIST

### Patent Literature

PTL 1: International Publication WO2019/082859
PTL 2: Japanese Unexamined Application Publication (Translation of PCT Application) No. 2017-509951

### SUMMARY OF INVENTION

### Technical Problem

In recent years, devices have been developed to speed up the operation of the layers of a neural network model when the sparsity of the weight value group is high (i.e., when the number of weight values “0” in the weight value group is large). Hereafter, such devices are referred to as high-speed devices. The high-speed devices can speed up the operation when the sparsity of the weight value group is high more than general devices that perform operations on neural network models (hereinafter simply referred to as “general devices”).

However, the above high-speed devices have a restriction that, for example, the speed-up of operations cannot be achieved unless the sparsity is over a certain value. For example, even if a high-speed device with the restriction that operations cannot be accelerated unless the sparsity is 50% or higher executes operations on a layer with a weight value group whose sparsity is 30%, the operations cannot be accelerated.

Therefore, the object of the present invention is to provide a neural network model conversion device, a neural network model conversion method, and a computer-readable recording medium in which a neural network model conversion program is recorded, that can convert a neural network model so as to facilitate effective use of a high-speed device.

### Solution to Problem

A neural network model conversion device according to the present invention includes: division position determination means for determining a division position in a weight value group, which is a weight value group of at least one layer included in a given neural network model, and has a configuration kernels are arranged in a kernel direction, each of which is obtained by arranging at least one or more weight values in a channel direction; division means for obtaining multiple weight value groups by dividing the weight value group at the division position; and connection layer addition means for adding a connection layer that is a layer that connects respective output data obtained by calculating input data to the layer and respective weight value groups after division to make one output data, wherein the division position determination means, when regarding a ratio of the number of weight values that are 0 to the number of weight values in the weight value group as sparsity, determines the division position in the weight value group before division so that at least one weight value group after the division has sparsity higher than or equal to a predetermined value.

A neural network model conversion method according to the present invention is implemented by a computer, and includes: a division position determination process of determining a division position in a weight value group, which is a weight value group of at least one layer included in a given neural network model, and has a configuration kernels are arranged in a kernel direction, each of which is obtained by arranging at least one or more weight values in a channel direction; a division process of obtaining multiple weight value groups by dividing the weight value group at the division position; and a connection layer addition process of adding a connection layer that is a layer that connects respective output data obtained by calculating input data to the layer and respective weight value groups after division to make one output data, wherein, in the division position determination process, when regarding a ratio of the number of weight values that are 0 to the number of weight values in the weight value group as sparsity, the computer determines the division position in the weight value group before division so that at least one weight value group after the division has sparsity higher than or equal to a predetermined value.

A computer-readable recording medium according to the present invention is a computer-readable recording medium in which a neural network model conversion program is recorded, wherein the neural network model conversion program causes a computer to execute: a division position determination process of determining a division position in a weight value group, which is a weight value group of at least one layer included in a given neural network model, and has a configuration kernels are arranged in a kernel direction, each of which is obtained by arranging at least one or more weight values in a channel direction; a division process of obtaining multiple weight value groups by dividing the weight value group at the division position; and a connection layer addition process of adding a connection layer that is a layer that connects respective output data obtained by calculating input data to the layer and respective weight value groups after division to make one output data, wherein the neural network model conversion program causes the computer to execute, in the division position determination process, when regarding a ratio of the number of weight values that are 0 to the number of weight values in the weight value group as sparsity, determining the division position in the weight value group before division so that at least one weight value group after the division has sparsity higher than or equal to a predetermined value.

### Advantageous Effects of Invention

According to the present invention, a neural network model can be converted so as to facilitate effective use of a high-speed device.

### BRIEF DESCRIPTION OF DRAWING

FIG. 1 It depicts a schematic diagram showing an example of the configuration of a weight value group corresponding to one layer.

FIG. 2 It depicts an explanatory diagram showing the relationship among input data, weight value group, and output data.

FIG. 3 It depicts a block diagram showing an example configuration of a neural network model conversion device of the first example embodiment of the present invention.

FIG. 4 It depicts a schematic diagram showing an example of a division position in the case of dividing a weight value group in the kernel direction.

FIG. 5 It depicts a schematic diagram showing an example of two weight value groups obtained by division.

FIG. 6 It depicts a schematic diagram showing an example of multiple output data obtained by convolution operations between input data and respective weight value groups.

FIG. 7 It depicts a schematic diagram showing an example of one output data obtained at the connection layer.

FIG. 8 It depicts a flowchart showing an example of the processing flow of the first example embodiment of the present invention.

FIG. 9 It depicts a schematic diagram showing conversion of division target layer in the first example embodiment.

FIG. 10 It depicts a block diagram showing an example configuration of a neural network model conversion device of the second example embodiment of the present invention.

FIG. 11 It depicts a flowchart showing an example of the processing flow of the second example embodiment of the present invention.

FIG. 12 It depicts a schematic diagram showing conversion of division target layer in the second example embodiment.

FIG. 13 It depicts an explanatory diagram showing that the number of kernels in the weight value group of the division target layer, the number of channels in the output data of the division target layer, and the number of channels in the weight value group of the next layer are equal.

FIG. 14 It depicts a block diagram showing an example configuration of a neural network model conversion device of the third example embodiment of the present invention.

FIG. 15 It depicts a flowchart showing an example of the processing flow of the third example embodiment of the present invention.

FIG. 16 It depicts a schematic diagram showing conversion of division target layer and the next layer in the third example embodiment.

FIG. 17 It depicts a block diagram showing an example configuration of a neural network model conversion device of the fourth example embodiment of the present invention.

FIG. 18 It depicts a schematic diagram showing an example of a division position in the case of dividing a weight value group in the channel direction.

FIG. 19 It depicts a schematic diagram showing an example of two weight value groups obtained by division.

FIG. 20 It depicts a schematic diagram showing an example of multiple output data obtained by convolution operations between input data and respective weight value groups.

FIG. 21 It depicts a schematic diagram showing an example of one output data obtained at the connection layer.

FIG. 22 It depicts a flowchart showing an example of the processing flow of the fourth example embodiment of the present invention.

FIG. 23 It depicts a schematic diagram showing conversion of division target layer in the fourth example embodiment.

FIG. 24 It depicts a block diagram showing an example configuration of a neural network model conversion device of the fifth example embodiment of the present invention.

FIG. 25 It depicts a flowchart showing an example of the processing flow of the fifth example embodiment of the present invention.

FIG. 26 It depicts a schematic diagram showing conversion of division target layer in the fifth example embodiment.

FIG. 27 It depicts an explanatory diagram showing that the number of channels in the weight value group of the division target layer, the number of channels in the input data to the division target layer, and the number of kernels in the weight value group of the previous layer are equal.

FIG. 28 It depicts a block diagram showing an example configuration of a neural network model conversion device of the sixth example embodiment of the present invention.

FIG. 29 It depicts a flowchart showing an example of the processing flow of the sixth example embodiment of the present invention.

FIG. 30 It depicts a schematic diagram showing conversion of division target layer and the previous layer in the sixth example embodiment.

FIG. 31 It depicts a schematic diagram showing an example of computer configuration related to the neural network model conversion device of each example embodiment of the present invention.

FIG. 32 It depicts a block diagram showing an overview of the neural network model conversion device of the present invention.

### DESCRIPTION OF EMBODIMENTS

As mentioned above, a neural network model includes multiple layers and a weight value group is associated with a layer. The neural network model conversion device of the present invention is applied to at least one layer of the neural network model. The neural network model conversion device of the present invention may be applied to multiple layers of the neural network model.

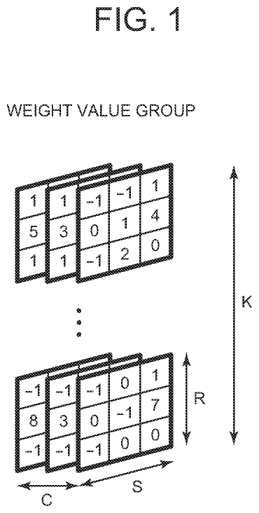

First, the configuration of a weight value group corresponding to one layer in the neural network model is explained. FIG. 1 is a schematic diagram showing an example of the configuration of a weight value group corresponding to one layer.

The weight value group has a configuration kernels are arranged in the kernel direction, each of which is obtained by arranging at least one or more weight values in the channel direction. The kernel is formed by arranging at least one or more weight values in the channel direction.

The example shown in FIG. 1 shows a weight value group in a configuration where each kernel is formed by arranging matrices of weight values placed in the R and S directions shown in FIG. 1 in the channel direction and the kernels are arranged in the kernel direction. In the example shown in FIG. 1, the channel direction is represented by the code C and the kernel direction by the code K.

The set of weight values obtained by arranging at least one or more weight values (in the example shown in FIG. 1, a 3-by-3 matrix with the weight values as elements) in the channel direction is called a kernel. A kernel is sometimes referred to as a filter. The number of channels in each kernel included in one weight value group is common.

The kernel direction is the direction in which the kernels are arranged.

In the weight value group shown in FIG. 1, the R direction, S direction, channel direction (C direction), and kernel direction (K direction) are shown as the directions in which weight values are arranged. Therefore, the weight value group shown in FIG. 1 can be said to be represented as a 4-dimensional array. In the explanation of each of the following example embodiments, the case in which the weight value group has configuration where each kernel is formed by arranging matrices of weight values placed in the R and S directions shown in FIG. 1 in the channel direction and the kernels are arranged in the kernel direction. However, the dimension of the array representing the weight value group is not limited to 4 dimensions.

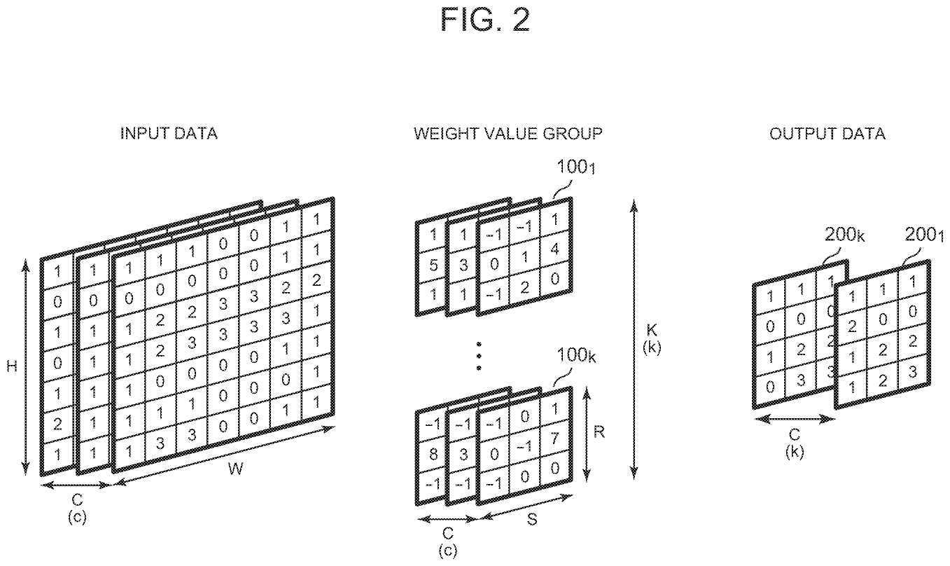

FIG. 2 is an explanatory diagram showing the relationship among input data, weight value group, and output data. In the weight value group, the number of channels (the number of matrices arranged in the channel direction) is c. Also, the number of kernels (the number of kernels arranged in the kernel direction) is k.

The input data has a configuration of c matrices arranged in the channel direction. That is, the number of channels of the input data and the number of channels of the weight value group of the layer to which the input data is input are equal. In the example shown in FIG. 2, the number of channels of the input data and the number of channels in the weight value group are both equal to c. However, the number of rows may be different and the number of columns may be different between the matrix of weight values placed in the R and S directions in the weight value group and the individual matrices in the input data (see FIG. 2).

The output data is obtained by performing a convolution operation using the input data and the weight value group. The convolution operation is performed using the input data for each individual kernel in the weight value group. The convolution operation between the input data and the j-th kernel (j is an integer between 1 and k) makes the data (matrix) that becomes the j-th channel in the output data. Therefore, the convolution operation between the input data and the first kernel 100₁ makes the data 200₁, which is the first channel in the output data. The convolution operation between the input data and the k-th kernel 100ₖ makes the data 200ₖ, which is the k-th channel in the output data. Therefore, each kernel in the weight value group corresponds to each channel in the output data. The number of kernels in the weight value group is equal to the number of channels in the output data. As shown in FIG. 2, when the number of kernels in the weight value group is k, then the number of channels in the output data is also k.

The following is a description of the example embodiments of the present invention with reference to the drawings.

The neural network model conversion device of the example embodiment of the present invention divides the weight value group of a layer of the neural network model. The layer into which the weight value group is divided may be one or more than one. In each of the following example embodiments, for the sake of simplicity of explanation, one layer as the layer into which the weight value group is divided is focused on. The layer into which the weight value group is divided is referred to as the division target layer. In other words, there may be multiple division target layers, but in each of the following example embodiments, a single division target layer is focused on.

The division of a weight value group means that the layer corresponding to the weight value group is also divided.

It is assumed that the division target layer is predetermined. For example, the division target layer may be specified in advance by the administrator of the neural network model. At least one division target layer is defined.

It is assumed that the sparsity of the weight value group of the division target layer (the sparsity of the weight value group before the division) is lower than a predetermined value. Furthermore, it is assumed that there is a high-speed device that can perform the convolution operation between the weight value group having the sparsity higher than or equal to the predetermined value and the input data faster than general devices.

The division target layer is converted by not only being divided but also by the addition of other processing layers. As a result, the neural network model is converted.

In each example embodiment, it is assumed that the neural network model to be converted have been previously input to the neural network model conversion device in each example embodiment.

### Example Embodiment 1

In the first example embodiment of the present invention, it is assumed that the number of kernels in the weight value group of the division target layer is k. In the first example embodiment, it is also assumed that the weight values that are 0 are unevenly distributed in the kernel direction in the weight value group of the division target layer. In this example, it is assumed that the kernel closer to the first includes more weight values “0”, and the kernel closer to the k-th includes fewer weight values “0”. However, this type of bias is only an example. For example, the kernels may not be arranged in strict descending order based on the number of weight values “0”. For example, the kernels may be arranged in ascending order based on the number of weight values “0”.

In the first example embodiment, the neural network model conversion device divides the weight value group in the kernel direction.

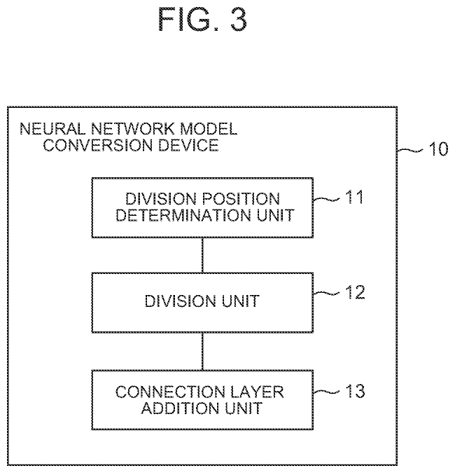

FIG. 3 is a block diagram showing an example configuration of a neural network model conversion device of the first example embodiment of the present invention. The neural network model conversion device 10 of this example embodiment includes a division position determination unit 11, a division unit 12, and a connection layer addition unit 13.

The division position determination unit 11 determines the division position in the weight value group of the division target layer. The division position determination unit 11 of this example embodiment determines the division position so that the weight value group before division is divided in the kernel direction. Therefore, in this example embodiment, the division position to be determined is the boundary between a kernel and a kernel.

Here, the division position determination unit 11 determines the division position so that at least one weight value group after the division has sparsity higher than or equal to a predetermined value. This predetermined value is the minimum value of sparsity at which the high-speed device can speed up the layer operation. In other words, when the sparsity is higher than or equal to the predetermined value, the high-speed device can accelerate the layer operation, and when the sparsity is lower than the predetermined value, the high-speed device cannot accelerate the layer operation.

In each example embodiment, the division position determination unit determines one division position in the weight value group, and the division unit divides the weight value group into two weight value groups as an example. However, in the case where there are multiple types of high-speed devices with different sparsity capable of high-speed processing, etc., in each example embodiment, the division position determination unit may determine two or more division positions in the weight value group, and the division unit may divide the weight value group into three or more weight value groups.

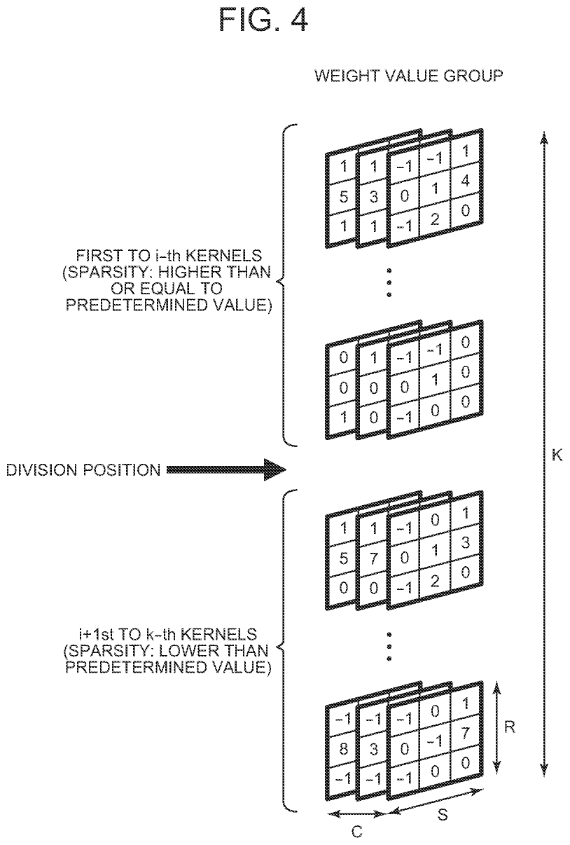

FIG. 4 is a schematic diagram showing an example of a division position in the case of dividing a weight value group in the kernel direction. As mentioned above, in this example, it is assumed that the kernel closer to the first includes more weight values “0”, and the kernel closer to the k-th includes fewer weight values “0”. In this case, it is assumed that the sparsity of the weight value group including the first to the i-th kernels is higher than or equal to the predetermined value, and the sparsity of the weight value group including the i+1st to the k-th kernels is lower than the predetermined value. In this case, the division position determination unit 11 determines the boundary between the i-th kernel and the i+1st kernel as the division position (see FIG. 4).

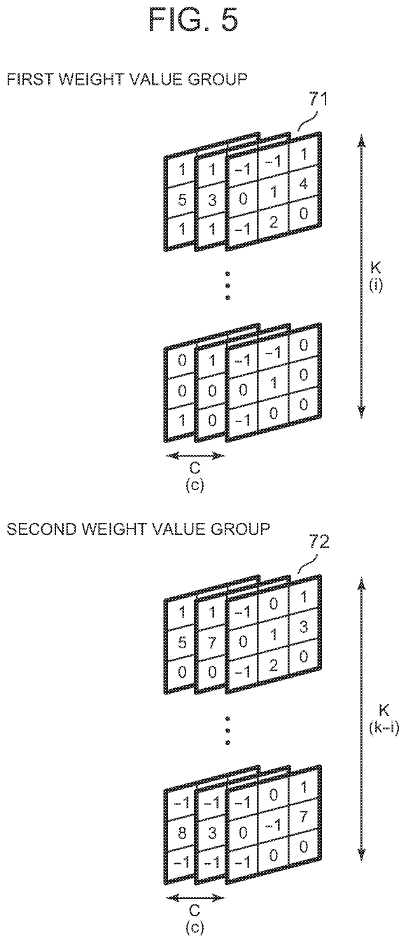

The division unit 12 divides the weight value group at the division position determined by the division position determination unit 11. FIG. 5 is a schematic diagram showing an example of two weight value groups obtained by division. The two weight value groups 71 and 72 obtained by the division correspond to one layer each. The fact that two weight value groups were obtained by division means that the division target layer is divided into two layers.

The first weight value group 71 obtained by the division includes the first to the i-th kernels in the weight value group before the division. In other words, the weight value group 71 includes i kernels.

The second weight value group 72 obtained by the division includes the i+1st to the k-th kernels in the weight value group before the division. In other words, the weight value group 72 contains k-i kernels.

The number of channels in weight value groups 71 and 72 is c and common.

The input data to the division target layer is input to each layer after the division, and convolution operations are performed in each layer.

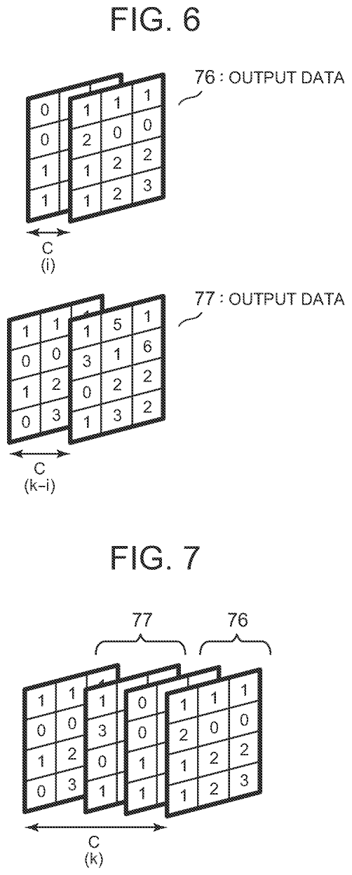

FIG. 6 is a schematic diagram showing an example of multiple output data obtained by convolution operations between input data and respective weight value groups 71, 72. As mentioned above, the number of kernels in the weight value group and the number of channels in the output data are equal. Therefore, the number of channels in the output data 76 obtained by the convolution operation between the input data and the weight value group 71 (see FIG. 5) is i. The i channels correspond to the i kernels of the weight value group 71. The number of channels in the output data 77 obtained by the convolution operation between the input data and the weight value group 72 (see FIG. 5) is k-i. The k-i channels correspond to the k-i kernels of the weight value group 72.

The connection layer addition unit 13 adds a connection layer to the neural network model. Specifically, the connection layer addition unit 13 adds a connection layer next to each layer after the division.

The connection layer is a layer that connects the respective output data obtained by the convolution operation between the input data to the division target layer and the respective weight value groups after the division to make one output data. In this example, the connection layer addition unit 13 adds a connection layer, which connects the respective output data 76, 77 (see FIG. 6) obtained by the convolution operation between the input data to the division target layer and the respective weight value groups 71, 72 (see FIG. 5) into one output data, next to each layer after the division.

When the weight value group is not divided, there is one output data of the division target layer, and the number of channels in the output data is k.

On the other hand, when the weight value group is divided into two, two output data 76, 77 are obtained as shown in FIG. 6. The two output data 76, 77 illustrated in FIG. 6 cannot be used as input data to the next layer of the division target layer as they are. By connecting the respective output data 76, 77 shown in FIG. 6 into one output data in the connection layer, the one output data can be used as the input data to the next layer of the division target layer.

In this example embodiment, the connection layer addition unit 13 adds a connection layer that makes each output data into one output data by connecting each output data 76, 77 in the channel direction so that the order of the kernels corresponds to the order of the channels of the output data corresponding to the kernels. In this example, the connection layer addition unit 13 adds the connection layer that connects the output data 76 having i channels corresponding to each kernel from the first to the i-th of the weight value group before the division, and the following output data 77 having k-i channels corresponding to each kernel from the i+1st to the k-th of the weight value group before the division. As shown in FIG. 7, one output data obtained after connecting is an output data having k channels.

The division position determination unit 11, the division unit 12, and the connection layer addition unit 13 are realized, for example, by a CPU (Central Processing Unit) of a computer operating according to a neural network model conversion program. For example, the CPU may read the neural network model conversion program from a program storage medium such as a program storage device of the computer, and operate as the division position determination unit 11, the division unit 12, and the connection layer addition unit 13 according to the neural network model conversion program.

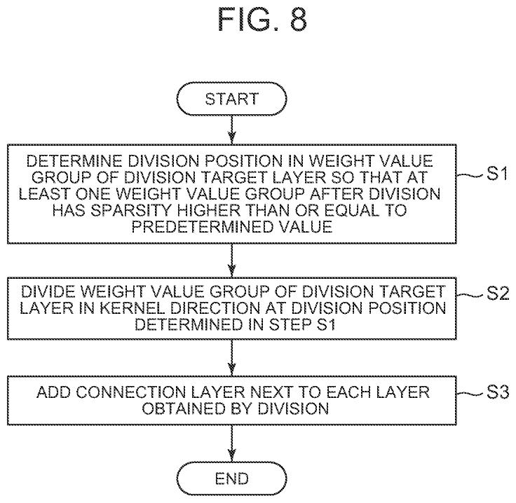

FIG. 8 is a flowchart showing an example of the processing flow of the first example embodiment of the present invention. The explanation of matters that have already been explained are omitted as appropriate.

First, the division position determination unit 11 determines the division position in the weight value group of the division target layer so that at least one weight value group after the division has the sparsity higher than or equal to the predetermined value (step S1). This division position is a division position when the weight value group is divided in the kernel direction.

Next, the divider 12 divides the weight value group of the division target layer in the kernel direction at the division position determined in step S1 (step S2).

Next, the connection layer addition unit 13 adds the connection layer next to each layer obtained by the division (step S3). In the first example embodiment, the process ends at step S3.

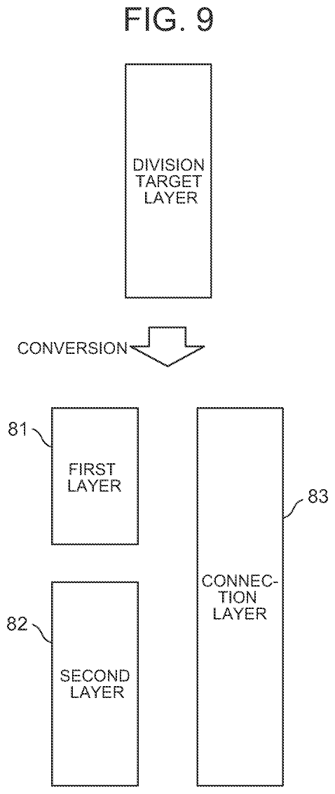

FIG. 9 is a schematic diagram showing conversion of division target layer in the first example embodiment. The division target layer in the given neural network model is converted into a first layer 81 and a second layer 82, which are obtained by the neural network model conversion device 10 of the first example embodiment dividing the weight value group of the division target layer in the kernel direction, and a connection layer 83. The sparsity of the first layer 81 is higher than or equal to the predetermined value, and the sparsity of the second layer 82 is lower than the predetermined value. Therefore, by having the high-speed device perform the convolution operation between the input data and the weight value group of the first layer 81, and having the general device perform the convolution operation between the input data and the weight value group of the second layer 82, the operation using the neural network model can be accelerated. Since the connection layer 83 is also added, the output data of each of the first layer 81 and the second layer 82 can be connected into one output data, and the one output data is identical to the output data of the division target layer. Therefore, even if the division target layer is converted as shown in FIG. 9, the calculation result of the neural network model as a whole does not change. Therefore, the neural network model can be converted so as to facilitate effective use of a high-speed device.

### Example Embodiment 2

The first example embodiment is an example embodiment applicable to the case where the weight values that are 0 are unevenly distributed in the kernel direction in the weight value group of the division target layer. There are cases in which the weight values that are 0 are not unevenly distributed in the kernel direction in the weight value group of the division target layer. The second example embodiment is an example embodiment applicable to the case where the weight values that are 0 are not unevenly distributed in the kernel direction in the weight value group of the division target layer. In the second example embodiment, it is assumed that kernels including many weight values “0” and kernels including only a few weight values “0” are not sorted in order of the number of weight values “0”.

The second example embodiment is also described assuming that the number of kernels in the weight value group of the division target layer is k. Also in the second example embodiment, the neural network model conversion device divides the weight value group in the kernel direction.

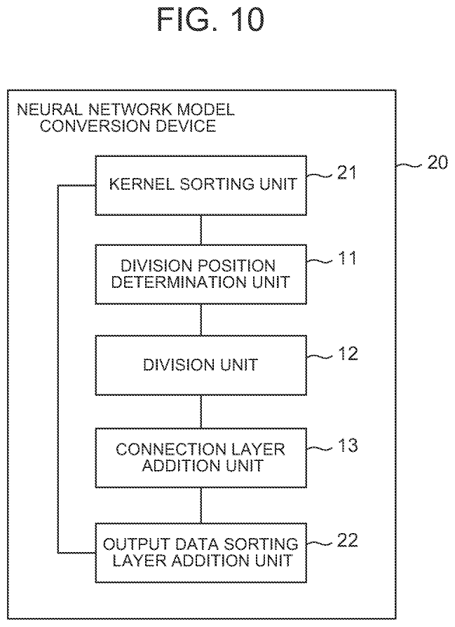

FIG. 10 is a block diagram showing an example configuration of a neural network model conversion device of the second example embodiment of the present invention. Elements similar to those in the first example embodiment are marked with the same codes as those shown in FIG. 3. The neural network model conversion device 20 of this example embodiment includes a kernel sorting unit 21, a division position determination unit 11, a division unit 12, a connection layer addition unit 13, and an output data sorting layer addition unit 22.

The kernel sorting unit 21 sorts the kernels included in the weight value group before the division of the division target layer according to a predetermined criterion. Specifically, the kernel sorting unit 21 sorts the kernels included in the weight value group based on the number of weight values “0” in each kernel. More specifically, the kernel sorting unit 21 sorts the kernels included in the weight value group before dividing the division target layer in descending or ascending order of the number of weight values that are 0. In the following, the case in which the kernel sorting unit 21 sorts the kernels included in the weight value group before the division in descending order of the number of weight values that are 0 will be used as an example. However, the kernel sorting unit 21 may sort the kernels in ascending order of the number of weight values that are 0.

After the kernel sorting unit 21 sorts the kernels in the weight value group before the division, the kernel sorting unit 21 sends sorting information indicating the order of each kernel before sorting and the order of each kernel after sorting to the output data sorting layer addition unit 22.

The operation of the division position determination unit 11, the division unit 12, and the connection layer addition unit 13 is the same as that of the division position determination unit 11, the division unit 12, and the connection layer addition unit 13 in the first example embodiment. However, in the second example embodiment, the division position determination unit 11, the division unit 12, and the connection layer addition unit 13 perform processing based on the weight value group after the kernel sorting by the kernel sorting unit 21.

The division position determination unit 11 determines the division position so that the weight value group after the kernel sorting by the kernel sorting unit 21 is divided in the kernel direction. In this case, the division position determination unit 11 determines the division position so that at least one weight value group after the division has sparsity higher than or equal to the predetermined value. The kernel sorting unit 21 sorts the kernels in the weight value group before the division in descending order (or ascending order) of the number of weight values that are 0. As a result, for example, the kernel closer to the first includes more weight value “0” and the kernel closer to the k-th kernel includes fewer weight value “0”. Therefore, the division position determination unit 11 can determine the division position so that at least one weight value group after the division has sparsity higher than or equal to the predetermined value.

It is assumed that in the weight value group after the kernel sorting, the sparsity of the weight value group including the first to the i-th kernels is higher than or equal to the predetermined value, and the sparsity of the weight value group including the i+1st to the k-th kernels is lower than the predetermined value. In this case, as in the case shown in FIG. 4, the division position determination unit 11 determines the boundary between the i-th kernel and the i+1st kernel as the division position. However, the order of the first, i-th, i+1st, k-th, etc. mentioned here is the order of the kernels after the kernel sorting by the kernel sorting unit 21.

The division unit 12 divides the weight value group at the division position determined by the division position determination unit 11. As a result, two weight value groups are obtained as shown in FIG. 5. The second example embodiment will also be explained below with reference to FIG. 5, FIG. 6, and FIG. 7 for convenience.

As mentioned above, the fact that two weight value group were obtained by the division means that the division target layer has been divided into two layers.

The first weight value group 71 (see FIG. 5), obtained by dividing the weight value group after sorting the kernels, includes the first to the i-th kernels in the weight value group before the division. In other words, the weight value group 71 includes i kernels.

The second weight value group 72 (see FIG. 5), obtained by dividing the weight value group after sorting the kernels, includes the i+1st to the k-th kernels in the weight value group before the division. In other words, the weight value group 72 includes k-i kernels.

The number of channels in the weight value groups 71 and 72 is c and common.

The input data to the division target layer is input to each layer after the division, and convolution operations are performed in each layer.

The convolution operation between the input data and the weight value group 71 (see FIG. 5) makes the output data 76 (see FIG. 6) in which the number of channels is i. The convolution operation between the input data and the weight value group 72 (see FIG. 5) makes the output data 77 (see FIG. 6) in which the number of channels is k-i.

The connection layer addition unit 13 adds a connection layer that makes each output data into one output data (see FIG. 7) by connecting each output data 76, 77 in the channel direction so that the order of the kernels after sorting by the kernel sorting unit 21 corresponds to the order of the channels of the output data corresponding to the kernels. In this example, the connection layer addition unit 13 adds a connection layer that makes one output data by connecting the output data 76 having i channels corresponding to each kernel from the first to the i-th of the weight value group before the division, and the following output data 77 having k-i channels corresponding to each kernel from the i+1st to the k-th of the weight value group before the division, in the channel direction. As mentioned above, the order of the first, i-th, i+1st, k-th, etc. is the order of the kernels after the kernel sorting by the kernel sorting unit 21.

Thus, in the second example embodiment, the order of the channels in the output data obtained at the connection layer corresponds to the order of the kernels after sorting by the kernel sorting unit 21.

The output data sorting layer addition unit 22 adds the output data sorting layer after the connection layer described above in the neural network model.

The output data sorting layer is a layer that sorts the channels of the one output data obtained in the connection layer to correspond to the order of the kernels in the weight value group before the kernel sorting, based on the change in the order of the kernels due to the sorting by the kernel sorting unit 21.

For example, it is assumed that a kernel (take Q) that was the first in the weight value group before the kernel sorting is sorted to the p-th kernel by the kernel sorting unit 21. Originally, the channel of the output data corresponding to kernel Q is the first channel, but in the one output data obtained by the connection layer, the channel corresponding to kernel Q is the p-th channel. The output data sorting layer sorts the p-th channel of the output data to the first channel. The output data sorting layer sorts each of the other channels in the same way.

The output data sorting layer addition unit 22 can determine, based on the sorting information described above, how to sort the channels of the one output data obtained by the connection layer so that the order of the channels of the output data corresponds to the order of the kernels in the weight value group before the kernel sorting. Therefore, the output data sorting layer addition unit 22 can create the output data sorting layer that specifies how to sort the channels of the output data based on the sorting information, and add the output data sorting layer after the connection layer described above.

In the one output data after sorting of the channels by the output data sorting layer, the order of the channels corresponds to the order of the kernels before sorting of the kernels by the kernel sorting unit 21. Therefore, the one output data obtained by the output data sorting layer can be used as input data to the next layer of the division target layer.

The kernel sorting unit 21, the division position determination unit 11, the division unit 12, the connection layer addition unit 13, and the output data sorting layer addition unit 22 are realized, for example, by a CPU of a computer operating according to a neural network model conversion program. For example, the CPU may read the neural network model conversion program from a program storage medium such as a program storage device of the computer, and operate as the kernel sorting unit 21, the division position determination unit 11, the division unit 12, the connection layer addition unit 13 and the output data sorting layer addition unit 22, according to the neural network model conversion program.

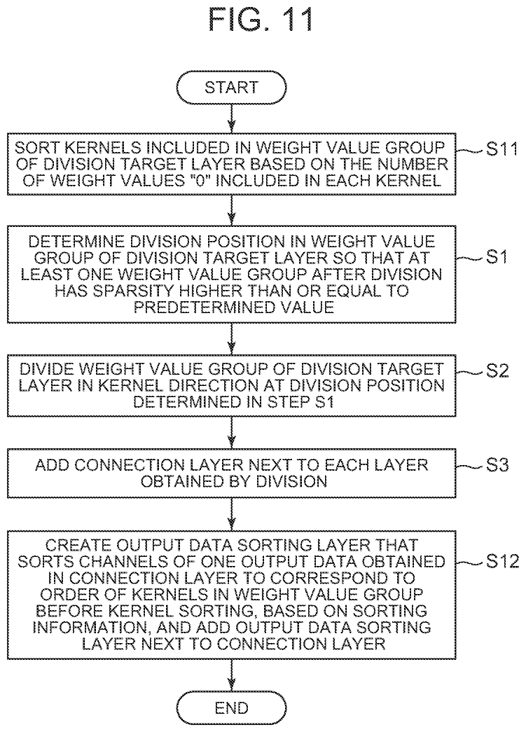

FIG. 11 is a flowchart showing an example of the processing flow of the second example embodiment of the present invention. The explanation of matters that have already been explained are omitted as appropriate. In addition, steps S1 to S3 shown in FIG. 11 are similar to steps S1 to S3 of the first example embodiment (see FIG. 8), except that the processing is based on the weight value group after kernel sorting, and the explanation is omitted.

In the second example embodiment, the kernel sorting unit 21 first sorts the kernels included in the weight value group of the division target layer based on the number of weight values “0” included in each kernel (step S11). For example, the kernel sorting unit 21 sorts the kernels included in the weight value group of the division target layer in descending order of the number of weight values “0”. The kernel sorting unit 21 also sends sorting information indicating the order of each kernel in the weight value group before sorting and the order of each kernel after sorting to the output data sorting layer addition unit 22.

After step S11, the neural network model conversion device 20 performs steps S1-S3 based on the weight value group after kernel sorting.

After step S3, the output data sorting layer addition unit 22 creates the output data sorting layer that sorts the channels of the one output data obtained in the connection layer to correspond to the order of the kernels in the weight value group before the kernel sorting, based on the aforementioned sorting information. Then, the output data sorting layer addition unit 22 adds the output data sorting layer next to the connection layer (step S12). In the second example embodiment, the process ends at step S12.

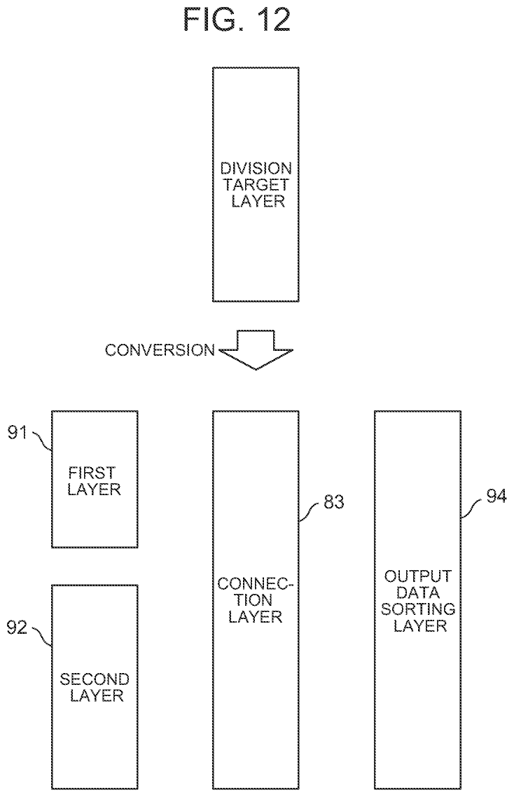

FIG. 12 is a schematic diagram showing conversion of division target layer in the second example embodiment. The first layer 91 and the second layer 92 are two layers obtained by the division unit 12 (see FIG. 10) dividing the weight value group after the kernel sorting. The sparsity of the first layer 91 is higher than or equal to the predetermined value, and the sparsity of the second layer 92 is lower than the predetermined value. Therefore, by having the high-speed device perform the convolution operation between the input data and the weight value group of the first layer 91, and having the general device perform the convolution operation between the input data and the weight value group of the second layer 92, the operation using the neural network model can be accelerated. The connection layer 83 is similar to the connection layer 83 shown in FIG. 9 and connects the output data of each of the first layer 91 and second layer 92 into one output data. The output data sorting layer 94 sorts the order of the channels of the one output data so that the order of the channels of the one output data corresponds to the order of the kernels in the weight value group before the kernel sorting by the kernel sorting unit 21. The output data obtained by this channel sorting is the same as the output data of the division target layer. Therefore, even if the division target layer is converted as shown in FIG. 12, the calculation result of the neural network model as a whole does not change. Therefore, the neural network model can be converted so as to facilitate effective use of a high-speed device.

### Example Embodiment 3

Similar to the second example embodiment, the third example embodiment is also applicable when the weight values that are 0 are not unevenly distributed in the kernel direction in the weight value group of the division target layer.

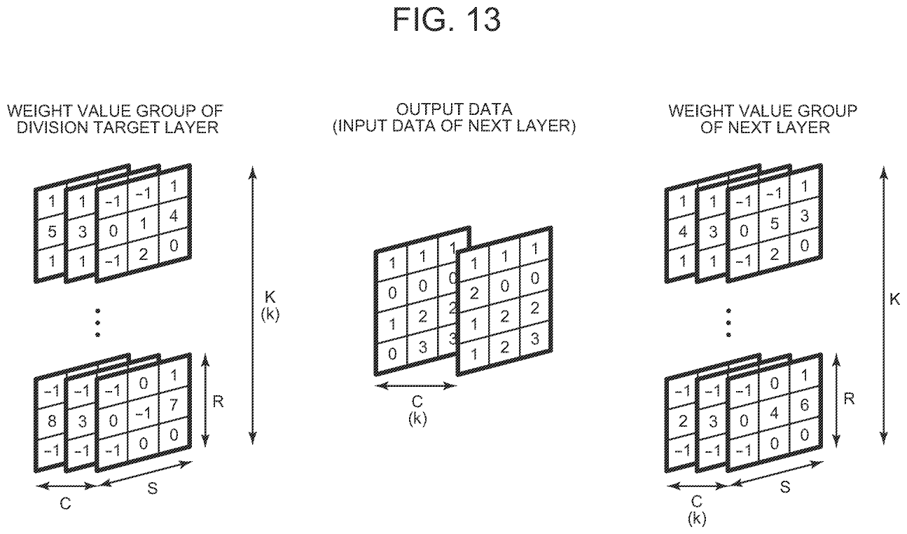

The third example embodiment is also described assuming that the number of kernels in the weight value group of the division target layer is k. In this case, the number of the channels of the output data obtained in the division target layer is k. The next layer after the division target layer is denoted as the next layer. Here, the division target layer is a convolutional layer, and the next convolutional layer after the division target layer is denoted as the next layer, and the case where the division target layer and the next layer are continuous is used as an example. Assuming that the neural network model is not converted, the convolution operation is performed in the next layer using the output data of the division target layer as input data. The number of the channels in the weight value group of the next layer is equal to the number of the channels in the input data of the next layer, which is k. In other words, the number of the kernels in the weight value group of the division target layer, the number of the channels in the output data of the division target layer, and the number of the channels in the weight value group of the next layer are all k, as shown in FIG. 13.

Also in the third example embodiment, the neural network model conversion device divides the weight value group of the division target layer in the kernel direction. Furthermore, in the third example embodiment, the neural network model conversion device sorts the channels of the next layer of the division target layer. In other words, in the third example embodiment, not only the division target layer but also the next layer of the division target layer is converted.

In the second example embodiment, as shown in FIG. 12, the output data sorting layer 94 is added next to the connection layer 83, so that the output data obtained in the output data sorting layer 94 is the same as the output data in the division target layer.

On the other hand, in the third example embodiment, the output data sorting layer 94 (see FIG. 12) is not added, but instead the channels of the next layer of the division target layer are sorted as described above. This ensures that the same output data as the output data of the next layer of the division target layer in the case where the neural network model is not converted is obtained from the next layer with sorted channels.

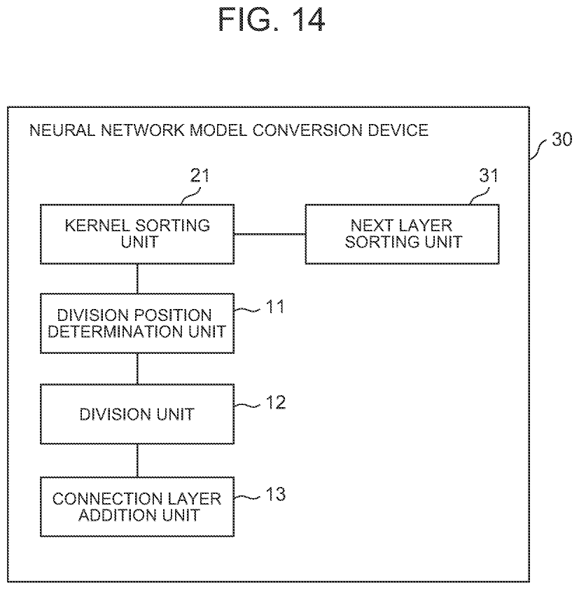

FIG. 14 is a block diagram showing an example configuration of a neural network model conversion device of the third example embodiment of the present invention. Elements similar to those in the second example embodiment are marked with the same codes as those shown in FIG. 10. The neural network model conversion device 30 of this example embodiment includes a kernel sorting unit 21, a next layer sorting unit 31, a division position determination unit 11, a division unit 12, and a connection layer addition unit 13.

The operation of the kernel sorting unit 21, the division position determination unit 11, the division unit 12, and the connection layer addition unit 13 is the same as the operation of the kernel sorting unit 21, the division position determination unit 11, the division unit 12, and the connection layer addition unit 13 in the second example embodiment. Therefore, the explanation of the operation of the kernel sorting unit 21, the division position determination unit 11, the division unit 12, and the connection layer addition unit 13 is omitted. The neural network model conversion device 30 does not include the output data sorting layer addition unit 22 of the second example embodiment.

Thus, in the third example embodiment, the division target layer is converted into the first layer 91, the second layer 92, and the connection layer 83 shown in FIG. 12. The output data sorting layer 94 (see FIG. 12) is not provided.

As described above, the operation of the kernel sorting unit 21 is similar to the operation of the kernel sorting unit 21 in the second example embodiment. However, in the third example embodiment, the kernel sorting unit 21 sorts the kernels in the weight value group before the division and then sends sorting information indicating the order of each kernel before sorting and the order of each kernel after sorting to the next layer sorting unit 31.

The next layer sorting unit 31 sorts the channels in the weight value group of the next layer of the division target layer according to the order of the kernels sorted by the kernel sorting unit 21.

In the next layer, the convolution operation is performed using the input data (in other words, one output data obtained by the connection layer added by the connection layer addition unit 13) and the weight value group of the next layer. As explained in the second example embodiment, the order of the channels of the output data obtained by the connection layer corresponds to the order of the kernels after sorting by the kernel sorting unit 21. Therefore, when the order of the channels of the weight value group of the next layer remains in the original order, the channels of the input data to the next layer do not correspond to the channels of the weight value group of the next layer. As a result, the output data of the next layer will be different from the output data obtained in the next layer when the neural network model is not converted. Then, the calculation result of the neural network model as a whole would also change.

To prevent such a situation, the next layer sorting unit 31 sorts the channels of the weight value group of the next layer of the division target layer according to the order of the kernels sorted by the kernel sorting unit 21.

For example, it is assumed that a kernel (take Q) that was the first in the weight value group before the kernel sorting is sorted to the p-th kernel by the kernel sorting unit 21. Then, in the one output data (input data to the next layer) obtained at the connection layer, the channel corresponding to kernel Q is the p-th channel. Therefore, the next layer sorting unit 31 sorts the first channel to the p-th channel in the weight value group of the next layer. The next layer sorting unit 31 sorts the other channels in the weight value group of the next layer in the same way. As a result, each channel of the input data to the next layer (i.e., the output data of the connection layer) and each channel of the weight value group of the next layer become corresponding channels. The output data obtained in the connection layer is different from the output data obtained in the division target layer, but the output data obtained in the next layer of the division target layer and the output data obtained in the next layer where the channels are sorted are the same. Therefore, even if the division target layer and its next layer are converted, the calculation result of the neural network model as a whole does not change.

When the next layer sorting unit 31 sorts the channels of the weight value group of the next layer of the division target layer according to the order of the kernels sorted by the kernel sorting unit 21, the next layer sorting unit 31 can refer to the sorting information described above to sort the channels. The sorting information indicates the order of each kernel in the weight value group of the division target layer before sorting and the order of each kernel after sorting. Therefore, based on the sorting information, the next layer sorting unit 31 can sort the channels of the weight value group of the next layer of the division target layer so as to correspond to the order of the kernels after the sorting.

The kernel sorting unit 21, the next layer sorting unit 31, the division position determination unit 11, the division unit 12, and the connection layer addition unit 13 are realized, for example, by a CPU of a computer operating according to a neural network model conversion program. For example, the CPU may read the neural network model conversion program from a program storage medium such as a program storage device of the computer, and operate as the kernel sorting unit 21, the next layer sorting unit 31, the division position determination unit 11, the division unit 12 and the connection layer addition unit 13.

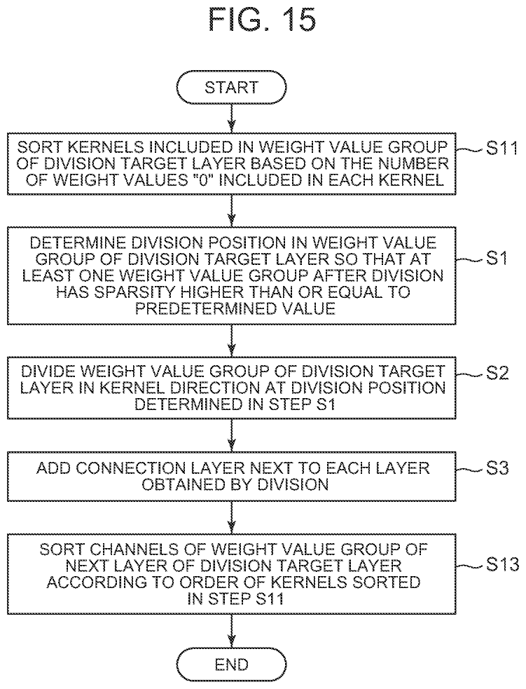

FIG. 15 is a flowchart showing an example of the processing flow of the third example embodiment of the present invention. The explanation of matters that have already been explained are omitted as appropriate. Step S11 and steps S1 to S3 shown in FIG. 15 are similar to step S11 and steps S1 to S3 in the second example embodiment (see FIG. 11), and detailed explanations are omitted.

First, the kernel sorting unit 21 sorts the kernels included in the weight value group of the division target layer based on the number of weight values “0” included in each kernel (step S11). Then, the kernel sorting unit 21 sends the sorting information indicating the order of each kernel in the weight value group before sorting and the order of each kernel after sorting to the next layer sorting unit 31.

After step S11, the neural network model conversion device 30 performs steps S1-S3 based on the weight value group after kernel sorting.

After step S3, the next layer sorting unit 31 sorts the channels of the weight value group of the next layer of the division target layer according to the order of the kernels sorted in step S11 (step S13). At this point, the next layer sorting unit 31 may determine how to sort the channels based on the sorting information.

The neural network model conversion device 30 may perform step S13 between step S11 and step S1.

FIG. 16 is a schematic diagram showing conversion of division target layer and the next layer in the third example embodiment. Layers similar to those shown in FIG. 12 are marked with the same codes as in FIG. 12. In the third example embodiment, the division target layer is converted into the first layer 91, the second layer 92 and the connection layer 83. The next layer of the division target layer is converted to the next layer 95 after channel sorting by the next layer sorting unit 31. As already explained with reference to FIG. 12, by having the high-speed device perform the convolution operation between the input data and the weight value group of the first layer 91, and having the general device perform the convolution operation between the input data and the weight value group of the second layer 92, the operation using the neural network model can be accelerated. In addition, the output data of the next layer in the case of no conversion of the neural network model and the output data of the next layer 95 after channel sorting are identical. Therefore, even if the division target layer and the next layer are converted as shown in FIG. 16, the calculation result of the neural network model as a whole does not change. Therefore, the neural network model can be converted so as to facilitate effective use of a high-speed device.

In general, in a neural network model, there may be a normalization layer or an activation function layer between a convolutional layer and another convolutional layer. In such cases, this example embodiment can be applied without problems. Specifically, no special measures are required for the layers that do not have weight values, such as the activation function layer, because they are not affected by the sorting. On the other hand, for layers that have weight values for each channel, such as the normalization layer (e.g., the Batch Normalization layer), the next layer sorting unit 31 sorts the weight value group of this layer in the same way as the weight value group of the next layer based on the sorting information, and the output data of the next layer can be the same as the output data of the next layer in the case of no conversion of the neural network model. This is the same in the case where a normalization layer or an activation function layer exists between the division target layer (convolutional layer) and the previous layer in the sixth example embodiment described below. In other words, in the sixth example embodiment described below, when a layer with a weight value group, such as a normalization layer, exists between the division target layer and the previous layer, the weight value group of the layer is sorted based on the sorting information in the same way as the weight value group of the previous layer.

### Example Embodiment 4

In the fourth example embodiment of the present invention, it is assumed that the number of channels in the weight value group of the division target layer is c and the number of kernels is k. In the fourth example embodiment, it is also assumed that the weight values that are 0 are unevenly distributed in the channel direction in the weight value group of the division target layer. In this example, it is assumed that the channel closer to the first channel includes more weight values “0” and the channel closer to the c-th channel includes fewer weight values “0”. However, this type of bias is only an example. For example, the channels may not be arranged in strict descending order based on the number of weight values “0”. For example, the channels may be arranged in ascending order based on the number of weight values “0”.

In the fourth example embodiment, the neural network model conversion device divides the weight value group in the channel direction.

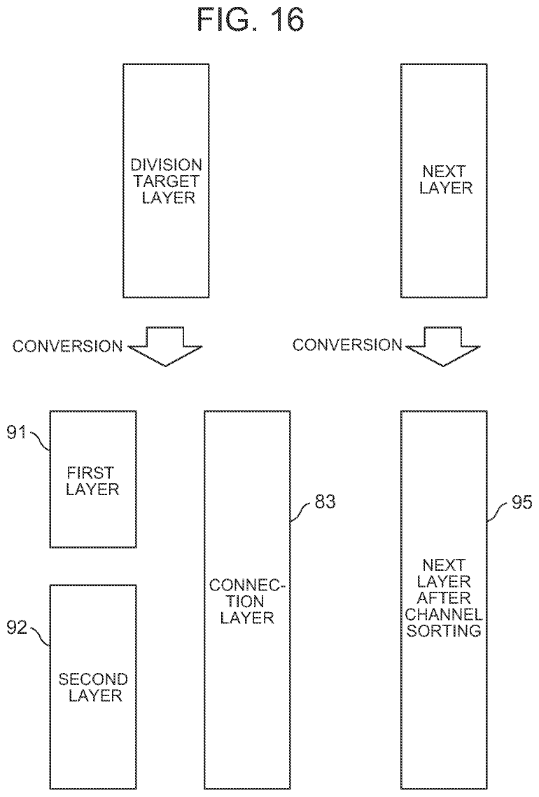

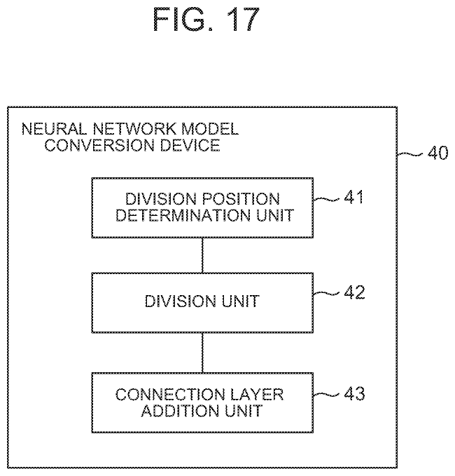

FIG. 17 is a block diagram showing an example configuration of a neural network model conversion device of the fourth example embodiment of the present invention. The neural network model conversion device 40 of this example embodiment includes a division position determination unit 41, a division unit 42, and a connection layer addition unit 43.

The division position determination unit 41 determines the division position in the weight value group of the division target layer. The division position determination unit 41 of this example embodiment determines the division position so that the weight value group before division is divided in the channel direction. Therefore, in this example embodiment, the division position to be determined is the boundary between a channel and a channel.

Here, the division position determination unit 41 determines the division position so that at least one weight value group after the division has sparsity higher than or equal to a predetermined value. This predetermined value is the minimum value of sparsity at which the high-speed device can speed up the layer operation.

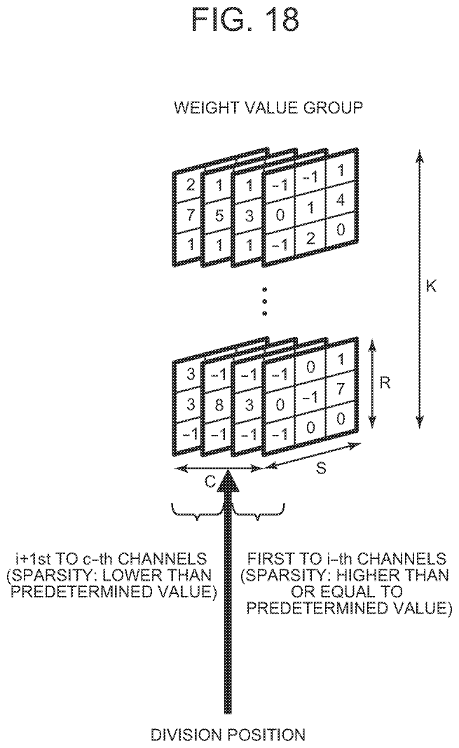

FIG. 18 is a schematic diagram showing an example of a division position in the case of dividing a weight value group in the channel direction. As mentioned above, in this example, it is assumed that the channel closer to the first channel includes more weight values “0”, and the channel closer to the c-th channel includes fewer weight values “0”. In this case, it is assumed that the sparsity of the weight value group including the first to the i-th channels is higher than or equal to the predetermined value, and the sparsity of the weight value group including the i+1st to the c-th channels is lower than the predetermined value. In this case, the division position determination unit 41 determines the boundary between the i-th channel and the i+1st channel as the division position (see FIG. 18).

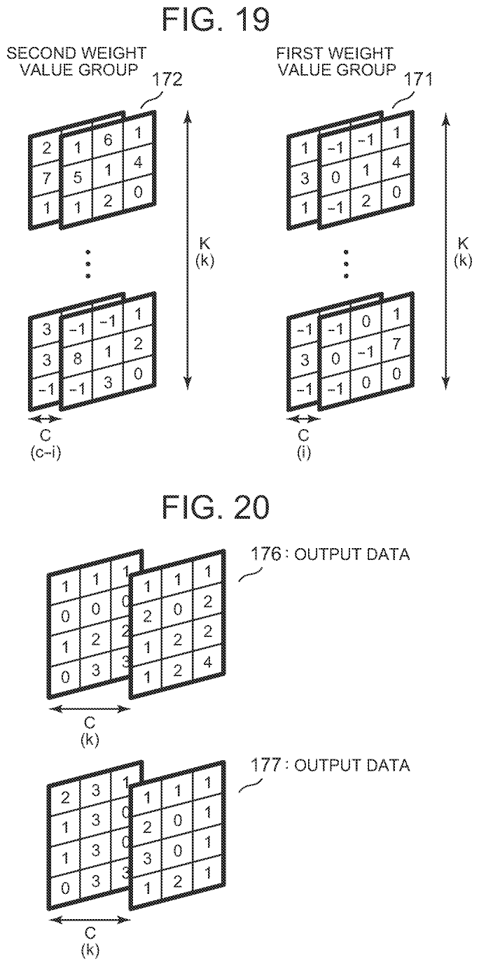

The division unit 42 divides the weight value group at the division position determined by the division position determination unit 41. FIG. 19 is a schematic diagram showing an example of two weight value groups obtained by division. The two weight value groups 171 and 172 obtained by the division correspond to one layer each. As already explained, the fact that two weight value groups were obtained by division means that the division target layer is divided into two layers.

The first weight value group 171 obtained by the division includes the first to the i-th channels in the weight value group before the division. In other words, the weight value group 171 includes i channels.

The second weight value group 172 obtained by the division includes the i+1st to c-th channels in the weight value group before the division. In other words, the weight value group 172 includes c-i channels.

The number of kernels in the weight value groups 171 and 172 is k and common.

It is assumed that each weight value group 171, 172 after the division has information indicating which channels before the division are included in the weight value group. This information is hereinafter referred to as channel information. For example, the weight value group 171 has channel information indicating the first to i-th channels. The weight value group 172 has channel information indicating the i+1st to the c-th channels. The channel information, for example, can be assigned to each weight value group after the division, by the division unit 42.

The input data to the division target layer is input to each layer after the division, and the convolution operation is performed in each layer. In the convolution operation between the input data and the weight value group 171, the channels (from the first to the i-th channels) corresponding to the channels indicated by the channel information in the weight value group 171 are extracted from the input data, and the convolution operation between the data consisting of the extracted i channels and the weight value group 171 is performed. Similarly, in the convolution operation between the input data and the weight value group 172, the channels (from the i+1st to the c-th channels) corresponding to the channels indicated by the channel information in the weight value group 172 are extracted from the input data, and the convolution operation between the data consisting of the extracted c-i channels and the weight value group 172 is performed.

FIG. 20 is a schematic diagram showing an example of multiple output data obtained by convolution operations between input data and respective weight value groups 171, 172. As mentioned above, the number of the kernels in the weight value group and the number of the channels in the output data are equal. The number of the kernels in the weight value group 171 and the number of the kernels in the weight value group 172 are k in common (see FIG. 19). Therefore, the number of the channels in the output data 176 obtained by the convolution operation between the input data and the weight value group 171 is k. Also, the number of the channels in the output data 177 obtained by the convolution operation between the input data and the weight value group 172 is k. Therefore, the number of channels of the multiple output data 176 and 177 is k and common, and the multiple output data 176 and 177 have a common configuration. Therefore, each element of output data 176 corresponds one-to-one to each element of output data 177.

The connection layer addition unit 43 adds a connection layer to the neural network model. Specifically, the connection layer addition unit 43 adds a connection layer next to each layer after the division.

As already explained, the connection layer is a layer that connects the respective output data obtained by the convolution operation between the input data to the division target layer and the respective weight value groups after the division to make one output data. However, the connection layer in the fourth example embodiment is a connection layer that derives one output data by adding the corresponding elements in the respective output data. For example, when the output data 176 and 177 shown in FIG. 20 are obtained, the corresponding elements of the output data 176 and 177 are added together, and one output data whose elements are the result of the addition is derived by the connection layer. The configuration of this single output data is common to the configuration of output data 176, 177.

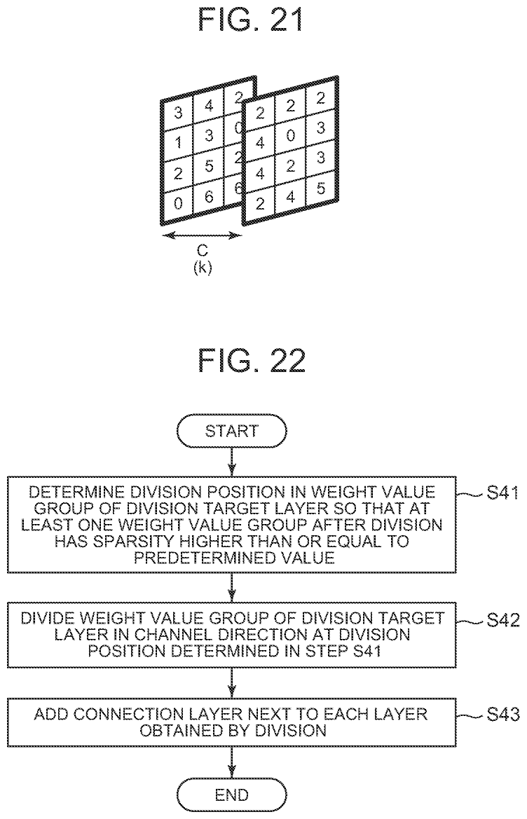

FIG. 21 is a schematic diagram showing an example of one output data obtained at the connection layer. As shown in FIG. 21, one output data obtained in the connection layer has k channels. The one data obtained at the connection layer is identical to one data obtained at the division target layer.

The division position determination unit 41, the division unit 42, and the connection layer addition unit 43 are realized, for example, by a CPU of a computer operating according to a neural network model conversion program. For example, the CPU may read the neural network model conversion program from a program storage medium such as a program storage device of the computer, and operate as the division position determination unit 41, the division unit 42, and the connection layer addition unit 43 according to the neural network model conversion program.

FIG. 22 is a flowchart showing an example of the processing flow of the fourth example embodiment of the present invention. The explanation of matters that have already been explained are omitted as appropriate.

First, the division position determination unit 41 determines the division position in the weight value group of the division target layer so that at least one weight value group after the division has the sparsity higher than or equal to the predetermined value (step S41). This division position is a division position when the weight value group is divided in the channel direction.

Next, the division unit 42 divides the weight value group of the division target layer in the channel direction at the division position determined in step S41 (step S42).

Next, the connection layer addition unit 43 adds the connection layer next to each layer obtained by the division (step S43). This connection layer is a connection layer that derives one output data by adding the corresponding elements in the respective output data. In the fourth example embodiment, the process ends at step S43.

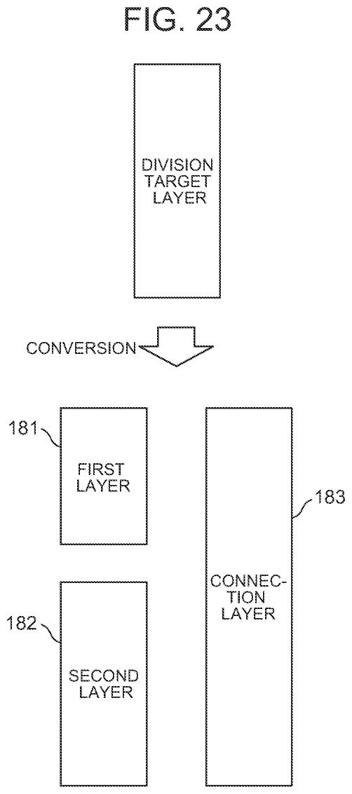

FIG. 23 is a schematic diagram showing conversion of division target layer in the fourth example embodiment. The division target layer in the given neural network model is converted into a first layer 181 and a second layer 182, which are obtained by the neural network model conversion device 40 of the fourth example embodiment dividing the weight value group of the division target layer in the channel direction, and a connection layer 183. The sparsity of the first layer 181 is higher than or equal to the predetermined value, and the sparsity of the second layer 182 is lower than the predetermined value. Therefore, by having the high-speed device perform the convolution operation between the input data and the weight value group of the first layer 181, and having the general device perform the convolution operation between the input data and the weight value group of the second layer 182, the operation using the neural network model can be accelerated. Since the connection layer 183 is also added, the output data of each of the first layer 181 and the second layer 182 can be connected into one output data, and the one output data is identical to the output data of the division target layer. Therefore, even if the division target layer is converted as shown in FIG. 23, the calculation result of the neural network model as a whole does not change. Therefore, the neural network model can be converted so as to facilitate effective use of a high-speed device.

### Example Embodiment 5

The fourth example embodiment is an example embodiment applicable to the case where the weight values that are 0 are unevenly distributed in the channel direction in the weight value group of the division target layer. There are cases in which the weight values that are 0 are not unevenly distributed in the channel direction in the weight value group of the division target layer. The fifth example embodiment is an example embodiment applicable to the case where the weight values that are 0 are not unevenly distributed in the channel direction in the weight value group of the division target layer. In the fifth example embodiment, it is assumed that channels including many weight values “0” and channels including only a few weight values “0” are not sorted in order of the number of weight values “0”.

The fifth example embodiment is also described assuming that the number of channels in the weight value group of the division target layer is c and the number of kernels is k. The neural network model conversion device of the fifth example embodiment also divides the weight value group in the channel direction as in the fourth example embodiment.

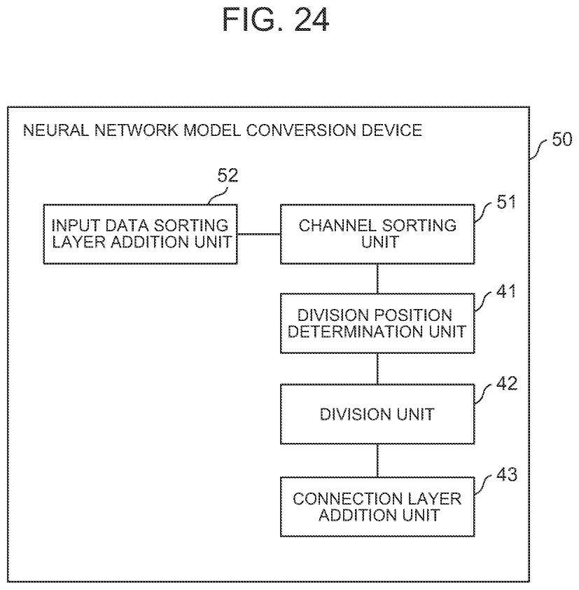

FIG. 24 is a block diagram showing an example configuration of a neural network model conversion device of the fifth example embodiment of the present invention. Elements similar to those in the fourth example embodiment are marked with the same codes as those shown in FIG. 17. The neural network model conversion device 50 of this example embodiment includes a channel sorting unit 51, a division position determination unit 41, a division unit 42, a connection layer addition unit 43, and an input data sorting layer addition unit 52.

The channel sorting unit 51 sorts the channels included in the weight value group before the division of the division target layer according to a predetermined criterion. Specifically, the channel sorting unit 51 sorts the channels included in the weight value group based on the number of weight values “0” in each channel. More specifically, the channel sorting unit 51 sorts the channels included in the weight value group before dividing the division target layer in descending or ascending order of the number of weight values that are 0. In the following, the case in which the channel sorting unit 51 sorts the channels included in the weight value group before the division in descending order of the number of weight values that are 0 will be used as an example. However, the channel sorting unit 51 may sort the channels in ascending order of the number of weight values that are 0.

After the channel sorting unit 51 sorts the channels in the weight value group before the division, the channel sorting unit 51 sends sorting information indicating the order of each channel before sorting and the order of each channel after sorting to the input data sorting layer addition unit 52.

The operation of the division position determination unit 41, the division unit 42, and the connection layer addition unit 43 is the same as that of the division position determination unit 41, the division unit 42, and the connection layer addition unit 43 in the fourth example embodiment. However, in the fifth example embodiment, the division position determination unit 41, the division unit 42, and the connection layer addition unit 43 perform processing based on the weight value group after the channel sorting by the channel sorting unit 51.

The division position determination unit 41 determines the division position so that the weight value group after the channel sorting by the channel sorting unit 51 is divided in the channel direction. In this case, the division position determination unit 41 determines the division position so that at least one weight value group after the division has sparsity higher than or equal to the predetermined value. The channel sorting unit 51 sorts the channels in the weight value group before the division in descending order (or ascending order) of the number of weight values that are 0. As a result, for example, the channel closer to the first channel includes more weight value “0” and the channel closer to the c-th channel includes fewer weight value “0”. Therefore, the division position determination unit 41 can determine the division position so that at least one weight value group after the division has sparsity higher than or equal to the predetermined value.

It is assumed that in the weight value group after the channel sorting, the sparsity of the weight value group including the first to the i-th channels is higher than or equal to the predetermined value, and the sparsity of the weight value group including the i+1st to the c-th channels is lower than the predetermined value. In this case, as in the case shown in FIG. 18, the division position determination unit 41 determines the boundary between the i-th channel and the i+1st channel as the division position. However, the order of the first, i-th, i+1st, c-th, etc. mentioned here is the order of the channels after the channel sorting by the channel sorting unit 51.

The division unit 42 divides the weight value group at the division position determined by the division position determination unit 41. As a result, two weight value groups are obtained as shown in FIG. 19. The fifth example embodiment will also be explained below with reference to FIG. 19, FIG. 20, and FIG. 21 for convenience.

The first weight value group 171 (see FIG. 19), obtained by dividing the weight value group after sorting the channels, includes the first to i-th channels in the weight value group before the division. In other words, the weight value group 171 includes i channels. The weight value group 171 also has channel information. The channel information is described in the fourth example embodiment, so it is not described here. In this example, the weight value group 171 has the channel information indicating the first to the i-th channels.

The second weight value group 172 (see FIG. 19), obtained by dividing the weight value group after sorting the channels, includes the i+1st to the c-th channels in the weight value group before the division. In other words, the weight value group 172 includes c-i channels. The weight value group 172 also has channel information. In this example, the weight value group 172 has the channel information indicating the i+1st to the c-th channel.

The channel information, for example, can be assigned by the division unit 42 to each weight value group after the division.

The convolution operation between a weight value group with channel information and input data is explained in the fourth example embodiment, so the explanation is omitted here.

The number of kernels in the weight value groups 171 and 172 is k and common.

In this example embodiment, the input data to the division target layer is sorted in the order of channels by the input data sorting layer described below. The input data whose channels have been sorted is input to each layer after the division, and the convolution operations are performed in each layer. The input data sorting layer, which sorts the order of channels of input data, is described below.

The convolution operation between the input data with the channels sorted and the weight value group 171 (see FIG. 19) makes the output data 176 (see FIG. 20) in which the number of channels is k. The convolution operation between the input data with the channels sorted and the weight value group 172 (see FIG. 19) makes the output data 177 (see FIG. 20) in which the number of channels is k.

The connection layer addition unit 43 adds the connection layer next to each layer after the division. The connection layer in this example embodiment is the same as the connection layer in the fourth example embodiment. That is, the connection layer in this example embodiment is a connection layer that derives one output data (see FIG. 21) by adding the corresponding elements in the respective output data obtained in each layer after the division.

The input data sorting layer addition unit 52 adds an input data sorting layer before the multiple layers obtained by the division of the weight value group of the division target layer. The input data sorting layer is a layer that sorts the channels of the input data to the division target layer according to the order of the channels sorted by the channel sorting unit 51. For example, it is assumed that the channel sorting unit 51 sorts the first channel of the weight value group of the division target layer to the q-th channel. In this case, the input data sorting layer sorts the first channel of the input data to the q-th channel. The input data sorting layer also sorts the other channels of the input data according to the order of the channels sorted by the channel sorting unit 51.

The input data sorting layer addition unit 52 refers to the sorting information to create the input data sorting layer. The sorting information in this example embodiment is information indicating the order of each channel in the weight value group of the division target layer before sorting and the order of each channel after sorting. Therefore, the input data sorting layer addition unit 52 can create the input data sorting layer by referring to the sorting information. As mentioned above, the input data sorting layer addition unit 52 adds the input data sorting layer before the multiple layers obtained by dividing the weight value group.

By the input data sorting layer, the order of the channels of the input data to the division target layer is sorted according to the order of the channels of the weight value group sorted by the channel sorting unit 51. The input data whose channels have been sorted in this way are input to each layer obtained by dividing the weight value group of the division target layer, and the convolution operations are performed in each layer.

In the fifth example embodiment, the channel sorting unit 51 sorts the order of the channels of the weight value groups of the division target layer, and the input data sorting layer addition unit 52 adds the input data sorting layer that sorts the channels of the input data according to that order. Therefore, the output data obtained in the connection layer in this example embodiment is the same as the output data obtained in the division target layer. Therefore, the one output data obtained in the connection layer can be used as input data to the next layer of the division target layer.

The channel sorting unit 51, the division position determination unit 41, the division unit 42, the connection layer addition unit 43, and the input data sorting layer addition unit 52 are realized, for example, by a CPU of a computer operating according to a neural network model conversion program. For example, the CPU may read the neural network model conversion program from a program storage medium such as a program storage device of the computer, and operate as the channel sorting unit 51, the division position determination unit 41, the division unit 42, the connection layer addition unit 43 and the input data sorting layer addition unit 52 according to the neural network model conversion program.

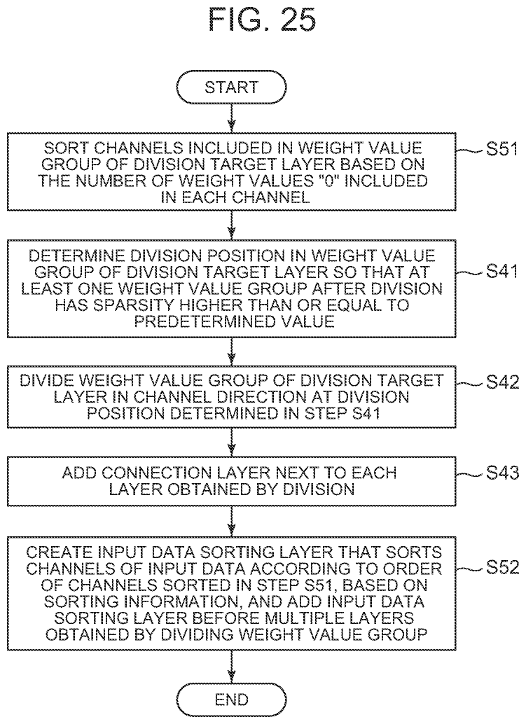

FIG. 25 is a flowchart showing an example of the processing flow of the fifth example embodiment of the present invention. The explanation of matters that have already been explained are omitted as appropriate. In addition, steps S41-S43 shown in FIG. 25 are similar to steps S41-S43 of the fourth example embodiment (see FIG. 22), except that the processing is based on the weight value group after channel sorting, and the explanation is omitted.

In the fifth example embodiment, the channel sorting unit 51 first sorts the channels included in the weight value group of the division target layer based on the number of weight values “0” included in each channel (step S51). For example, the channel sorting unit 51 sorts the channels included in the weight value group of the division target layer in descending order of the number of weight values “0”. In addition, the channel sorting unit 51 sends sorting information indicating the order of each channel in the weight value group before sorting and the order of each channel after sorting to the input data sorting layer addition unit 52.

After step S51, the neural network model conversion device 50 performs steps S41-S43 based on the weight value group after channel sorting.

After step S43, the input data sorting layer addition unit 52 creates the input data sorting layer that sorts the channels of the input data according to the order of the channels sorted in step S51, based on the sorting information. Then, the input data sorting layer addition unit 52 adds the input data sorting layer before the multiple layers obtained by dividing the weight value group (step S52). In the fifth example embodiment, the process ends at step S52.

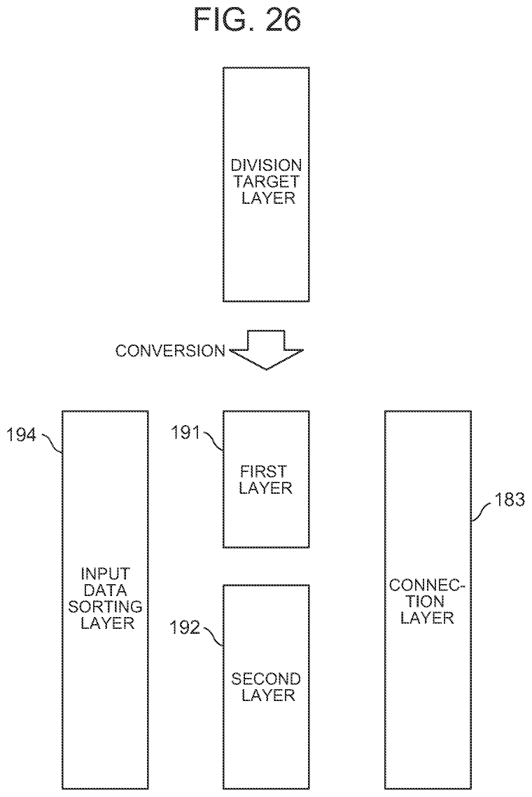

FIG. 26 is a schematic diagram showing conversion of division target layer in the fifth example embodiment. The first layer 191 and the second layer 192 are two layers obtained by the division unit 42 (see FIG. 24) dividing the weight value group after channel sorting. The sparsity of the first layer 191 is higher than or equal to the predetermined value, and the sparsity of the second layer 192 is lower than the predetermined value. Therefore, by having the high-speed device perform the convolution operation between the channel-sorted input data and the weight value group of the first layer 191, and having the general device perform the convolution operation between the channel-sorted input data and the weight value group of the second layer 192, the operation using the neural network model can be accelerated. The connection layer 183 is similar to the connection layer 183 shown in FIG. 23, and connects the output data of each of the first layer 191 and the second layer 192 into one output data. The input data sorting layer 194 sorts the channels of the input data according to the order of the channels of the weight value group sorted by the channel sorting unit 51. As a result, the one output data obtained by the connection layer 183 is identical to the output data of the division target layer. Therefore, even if the division target layer is converted as shown in FIG. 26, the calculation result of the neural network model as a whole does not change. Therefore, the neural network model can be converted so as to facilitate effective use of a high-speed device.

### Example Embodiment 6

Similar to the fifth example embodiment, the sixth example embodiment is also applicable when the weight values that are 0 are not unevenly distributed in the channel direction in the weight value group of the division target layer.

The sixth example embodiment is also described assuming that the number of channels in the weight value group of the division target layer is c.

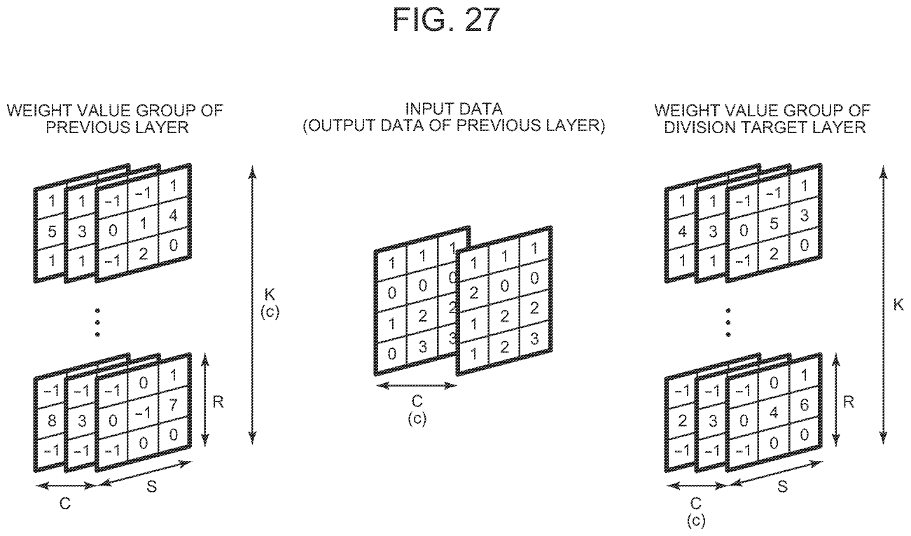

As explained in the third example embodiment, the number of kernels in the weight value group of the division target layer, the number of channels in the output data of the division target layer, and the number of channels in the weight value group of the next layer are common (see FIG. 13). Assume that the “next layer” of the third example embodiment is the division target layer, and consider the layer one before the division target layer (hereinafter referred to as the “previous layer”). In this case, as shown in FIG. 27, the number of channels in the weight value group of the division target layer, the number of channels in the input data to the division target layer (in other words, the output data of the previous layer), and the number of kernels in the weight value group of the previous layer are all c in common. Here, the case in which the division target layer is a convolutional layer and a convolutional layer before the division target layer is the previous layer and the previous layer and the division target layer are continuous is described as an example.

In the sixth example embodiment, the neural network model conversion device also divides the weight value group of the division target layer in the channel direction. Furthermore, in the sixth example embodiment, the neural network model conversion device sorts the kernels of the previous layer of the division target layer. In other words, in the sixth example embodiment, not only the division target layer but also the previous layer of the division target layer is converted.

In the fifth example embodiment, as shown in FIG. 26, the input data sorting layer 194 is added before the first layer 191 and the second layer 192, so that the output data obtained in the connection layer 183 is identical to the output data in the division target layer.

On the other hand, in the sixth example embodiment, the input data sorting layer 194 (see FIG. 26) is not added, but instead, the kernels in the previous layer of the division target layer are sorted, as described above. This ensures that the same data as the output data of the division target layer in the case where the neural network model is not converted is obtained from the connection layer.

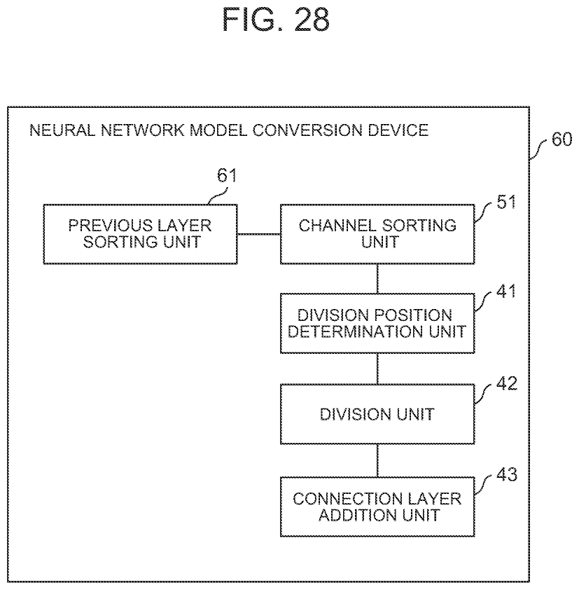

FIG. 28 is a block diagram showing an example configuration of a neural network model conversion device of the sixth example embodiment of the present invention. Elements similar to those in the fifth example embodiment are marked with the same codes as those shown in FIG. 24. The neural network model conversion device 60 of this example embodiment includes a channel sorting unit 51, a previous layer sorting unit 61, a division position determination unit 41, a division unit 42, and a connection layer addition unit 43.

The operation of the channel sorting unit 51, the division position determination unit 41, the division unit 42, and the connection layer addition unit 43 is the same as that of the channel sorting unit 51, the division position determination unit 41, the division unit 42, and the connection layer addition unit 43 in the fifth example embodiment. Therefore, the explanation of the operations of the channel sorting unit 51, the division position determination unit 41, the division unit 42, and the connection layer addition unit 43 is omitted. The neural network model conversion device 60 does not include the input data sorting layer addition unit 52 in the fifth example embodiment.

Thus, in the sixth example embodiment, the division target layer is converted into the first layer 191, the second layer 192, and the connection layer 183 shown in FIG. 26. The input data sorting layer 194 (see FIG. 26) is not provided.

As described above, the operation of the channel sorting unit 51 is similar to the operation of the channel sorting unit 51 in the fifth example embodiment. However, in the sixth example embodiment, after the channel sorting unit 51 sorts the channels in the weight value group before the division, the channel sorting unit 51 sends sorting information indicating the order of each channel before sorting and the order of each channel after sorting to the previous layer sorting unit 61.

The previous layer sorting unit 61 sorts the kernels of the weight value group of the previous layer of the division target layer according to the order of the channels sorted by the channel sorting unit 51.

For example, it is assumed that the channel sorting unit 51 sorts the first channel in the weight value group of the division target layer into the q-th channel. In this case, the previous layer sorting unit 61 sorts the first kernel of the weight value group of the previous layer to the q-th kernel. The previous layer sorting unit 61 also sorts the other kernels of the weight value group of the previous layer according to the order of the channels sorted by the channel sorting unit 51.

Each kernel in the weight value group of the previous layer corresponds to each channel of the output data of the previous layer. Therefore, by sorting the order of the kernels in the weight value group of the previous layer according to the order of the channels sorted by the channel sorting unit 51, the output data of the previous layer becomes the same as the input data obtained in the input data sorting layer in the fifth example embodiment. Then, based on the output data of the previous layer, processes of each layer obtained by division and the connection layer are performed, so the output data of the connection layer in this example embodiment is the same as the output data of the connection layer in the fifth example embodiment. Therefore, the output data of the connection layer in this example embodiment can be used as input data to the next layer of the division target layer.

When the previous layer sorting unit 61 sorts the kernels of the weight value group of the previous layer of the division target layer according to the order of the channels sorted by the channel sorting unit 51, the previous layer sorting unit 61 can refer to the above sorting information to sort the kernels. The sorting information indicates the order of each channel in the weight value group of the division target layer before sorting and the order of each channel after sorting. Therefore, based on the sorting information, the previous layer sorting unit 61 can sort the kernels included in the weight value group of the previous layer of the division target layer according to the order of the channels after the sorting.

The channel sorting unit 51, the previous layer sorting unit 61, the division position determination unit 41, the division unit 42, and the connection layer addition unit 43 are realized, for example, by a CPU of a computer operating according to a neural network model conversion program. For example, the CPU may read the neural network model conversion program from a program storage medium such as a program storage device of the computer, and operate as the channel sorting unit 51, the previous layer sorting unit 61, the division position determination unit 41, the division unit 42 and the connection layer addition unit 43 according to the neural network model conversion program.

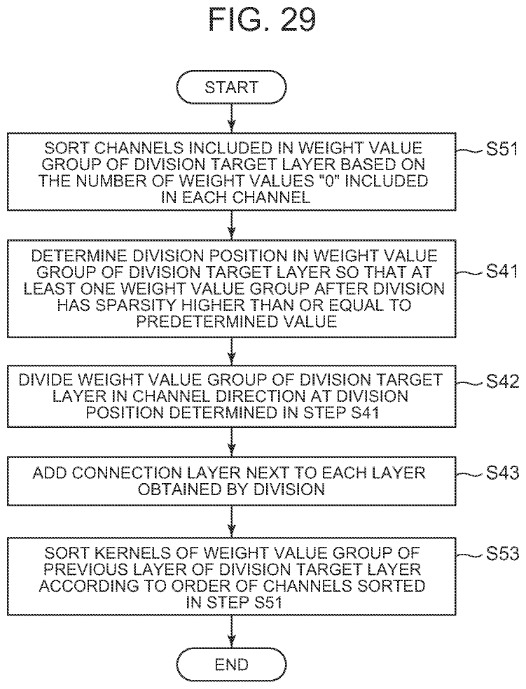

FIG. 29 is a flowchart showing an example of the processing flow of the sixth example embodiment of the present invention. The explanation of matters that have already been explained are omitted as appropriate. Step S51 and steps S41 to S43 shown in FIG. 29 are similar to step S51 and steps S41 to S43 (see FIG. 25) in the fifth example embodiment, and detailed explanations are omitted.

First, the channel sorting unit 51 sorts the channels included in the weight value group of the division target layer based on the number of weight values “0” included in each channel (step S51). Then, the channel sorting unit 51 sends the sorting information indicating the order of each channel in the weight value group before sorting and the order of each channel after sorting to the previous layer sorting unit 61.

After step S51, the neural network model conversion device 60 performs steps S41-S43 based on the weight value group after channel sorting.

After step S43, the previous layer sorting unit 61 sorts the kernels of the weight value group of the previous layer of the division target layer according to the order of the channels sorted in step S51 (step S53). At this time, the previous layer sorting unit 61 may determine how to sort the kernels based on the sorting information.

The neural network model conversion device 60 may perform step S53 between step S51 and step S41.

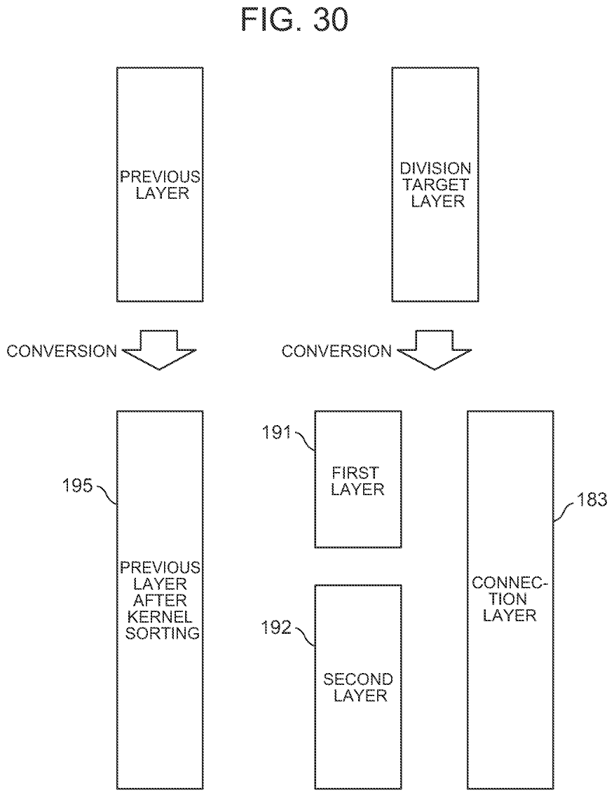

FIG. 30 is a schematic diagram showing conversion of division target layer and the previous layer in the sixth example embodiment. Layers similar to those shown in FIG. 26 are marked with the same codes as in FIG. 26. In the sixth example embodiment, the division target layer is converted into the first layer 191, the second layer 192 and the connection layer 183. The previous layer of the division target layer is converted to the previous layer 195 after kernel sorting by the previous layer sorting unit 61. By having the high-speed device perform the convolution operation between the input data and the weight value group of the first layer 191 and having the general device perform the convolution operation between the input data and the weight value group of the second layer 192, the operation using the neural network model can be accelerated. In addition, the output data of the division target layer in the case of no conversion of the neural network model and the output data obtained in the connection layer 183 are identical, due to the provision of the previous layer 195 after kernel sorting. Therefore, even if the division target layer and the previous layer are converted as shown in FIG. 30, the calculation result of the neural network model as a whole does not change. Therefore, the neural network model can be converted so as to facilitate effective use of a high-speed device.

There may be more than one division target layer in the neural network model. And different example embodiments of the present invention may be applied to different division target layers. However, the multiple division target layers cannot be defined so that the “next layer” of the third example embodiment overlaps with the “previous layer” of the sixth example embodiment.

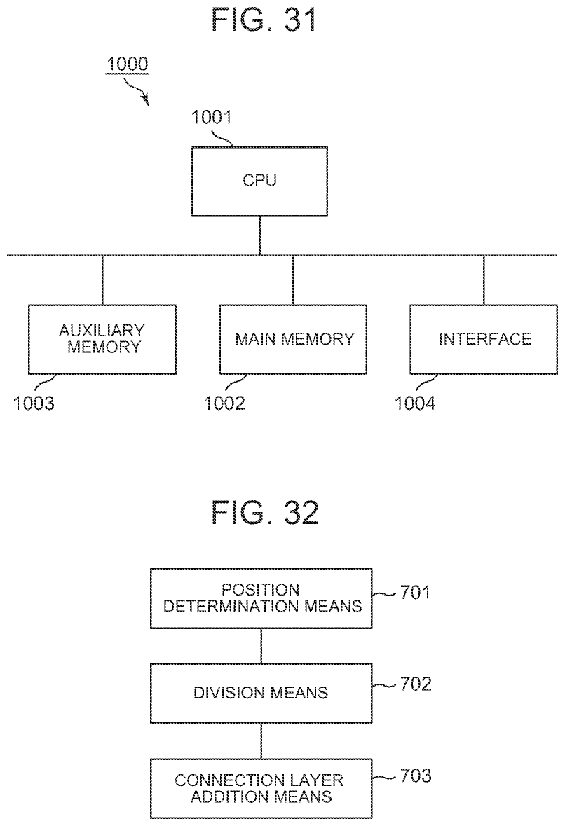

FIG. 31 is a schematic diagram showing an example of computer configuration related to the neural network model conversion device of each example embodiment of the present invention. The computer 1000 includes a CPU 100₁, a main memory 1002, an auxiliary memory 1003, and an interface 1004.

The neural network model conversion device of each example embodiment of the present invention is realized, for example, by the computer 1000. The operation of the neural network model conversion device is stored in the auxiliary memory 1003 in the form of a neural network model conversion program. The CPU 100₁ reads the program, expands the program in the main memory 1002, and executes the process described in each of the above example embodiments according to the program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), semiconductor memory, etc. When the program is delivered to the computer 1000 through a communication line, the computer 1000 may expand the program in the main memory 1002 and execute the process described in each of the above example embodiments according to the program.

Some or all of the components may be realized by general-purpose or dedicated circuitry, processor, or a combination of these. These may comprise a single chip or multiple chips connected via a bus. Some or all of the components may be realized by a combination of the above-mentioned circuitry, etc. and a program.

When some or all of components are realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

Next, an overview of the invention will be presented. FIG. 32 is a block diagram showing an overview of the neural network model conversion device of the present invention. The neural network model conversion device of the present invention includes division position determination means 701, division means 702, and connection layer addition means 703.

The division position determination means 701 (e.g., the division position determination unit 11, the division position determination unit 41) determines a division position in a weight value group, which is a weight value group of at least one layer included in a given neural network model, and has a configuration kernels are arranged in a kernel direction, each of which is obtained by arranging at least one or more weight values in a channel direction.

The division means 702 (e.g., the division unit 12, the division unit 42) obtains multiple weight value groups by dividing the weight value group at the division position.

The connection layer addition means 703 (e.g., the connection layer addition unit 13, the connection layer addition unit 43) adds a connection layer that is a layer that connects respective output data obtained by calculating input data to the layer and respective weight value groups after division to make one output data.

The division position determination means 701, when regarding a ratio of the number of weight values that are 0 to the number of weight values in the weight value group as sparsity, determines the division position in the weight value group before division so that at least one weight value group after the division has sparsity higher than or equal to a predetermined value.

Such a configuration allows the neural network model to be converted in a way that facilitates effective use of a high-speed device.

The above example embodiments of the present invention may also be described as the following supplementary notes, but are not limited to the following supplementary notes.

### (Supplementary Note 1)

A neural network model conversion device comprising:
division position determination means for determining a division position in a weight value group, which is a weight value group of at least one layer included in a given neural network model, and has a configuration kernels are arranged in a kernel direction, each of which is obtained by arranging at least one or more weight values in a channel direction;
division means for obtaining multiple weight value groups by dividing the weight value group at the division position; and
connection layer addition means for adding a connection layer that is a layer that connects respective output data obtained by calculating input data to the layer and respective weight value groups after division to make one output data,
wherein the division position determination means,
when regarding a ratio of the number of weight values that are 0 to the number of weight values in the weight value group as sparsity, determines the division position in the weight value group before division so that at least one weight value group after the division has sparsity higher than or equal to a predetermined value.

### (Supplementary Note 2)

The neural network model conversion device according to supplementary note 1,
wherein the division position determination means determines the division position so that the weight value group before the division is divided in the kernel direction,
the division means divides the weight value group before the division at the division position, and
the connection layer addition means adds the connection layer that makes the one output data by connecting the respective output data obtained by calculating the input data and the respective weight value groups after the division, in the channel direction.

### (Supplementary Note 3)

The neural network model conversion device according to supplementary note 1 or 2, further comprising:
kernel sorting means for sorting the kernels included in the weight value group before the division, according to a predetermined criterion,
wherein the division position determination means determines the division position so that the weight value group after kernel sorting is divided in the kernel direction,
the division means divides the weight value group before the division at the division position, and
the connection layer addition means adds the connection layer that makes the one output data by connecting the respective output data obtained by calculating the input data and the respective weight value groups after the division, in the channel direction, and
wherein the neural network model conversion device comprises:
output data sorting layer addition means for adding an output data sorting layer that sorts channels of the one output data to correspond to order of the kernels in the weight value group before kernel sorting, based on change in order of the kernels due to sorting by the kernel sorting means.

### (Supplementary Note 4)

The neural network model conversion device according to supplementary note 1 or 2, further comprising:
kernel sorting means for sorting the kernels included in the weight value group before the division, according to a predetermined criterion; and
next layer sorting means for sorting channels of next layer of the layer whose weight value group is divided according to order of the kernels sorted by the kernel sorting means,
wherein the division position determination means determines the division position so that the weight value group after kernel sorting is divided in the kernel direction,
the division means divides the weight value group before the division at the division position, and
the connection layer addition means adds the connection layer that makes the one output data by connecting the respective output data obtained by calculating the input data and the respective weight value groups after the division, in the channel direction.

### (Supplementary Note 5)

The neural network model conversion device according to supplementary note 3 or 4,
wherein the kernel sorting means sorts the kernels included in the weight value group before the division, in descending or ascending order of the number of weight values that are 0.

### (Supplementary Note 6)

The neural network model conversion device according to supplementary note 1,
wherein the division position determination means determines the division position so that the weight value group before the division is divided in the channel direction,
the division means divides the weight value group before the division at the division position, and
the connection layer addition means adds the connection layer that derives the one output data by adding corresponding elements in the respective output data obtained by calculating the input data and the respective weight value groups after the division.

### (Supplementary Note 7)

The neural network model conversion device according to supplementary note 1 or 6, further comprising:
channel sorting means for sorting the channels included in the weight value group before the division, according to a predetermined criterion; and
input data sorting layer addition means for adding an input data sorting layer that sorts channels of the input data according to order of the channels sorted by the channel sorting means,
wherein the division position determination means determines the division position so that the weight value group after channel sorting is divided in the channel direction,
the division means divides the weight value group before the division at the division position, and
the connection layer addition means adds the connection layer that derives the one output data by adding corresponding elements in the respective output data obtained by calculating the input data and the respective weight value groups after the division.

### (Supplementary Note 8)

The neural network model conversion device according to supplementary note 1 or 6, further comprising:
channel sorting means for sorting the channels included in the weight value group before the division, according to a predetermined criterion; and
previous layer sorting means for sorting kernels of weight value group of previous layer of the layer whose weight value group is divided according to order of the channels sorted by the channel sorting means,
wherein the division position determination means determines the division position so that the weight value group after channel sorting is divided in the channel direction,
the division means divides the weight value group before the division at the division position, and
the connection layer addition means adds the connection layer that derives the one output data by adding corresponding elements in the respective output data obtained by calculating the input data and the respective weight value groups after the division.

### (Supplementary Note 9)

The neural network model conversion device according to supplementary note 7 or 8,
wherein the channel sorting means sorts the channels included in the weight value group before the division, in descending or ascending order of the number of weight values that are 0.

### (Supplementary Note 10)

A neural network model conversion method, implemented by a computer, comprising:
a division position determination process of determining a division position in a weight value group, which is a weight value group of at least one layer included in a given neural network model, and has a configuration kernels are arranged in a kernel direction, each of which is obtained by arranging at least one or more weight values in a channel direction;
a division process of obtaining multiple weight value groups by dividing the weight value group at the division position; and
a connection layer addition process of adding a connection layer that is a layer that connects respective output data obtained by calculating input data to the layer and respective weight value groups after division to make one output data,
wherein, in the division position determination process,
when regarding a ratio of the number of weight values that are 0 to the number of weight values in the weight value group as sparsity, the computer determines the division position in the weight value group before division so that at least one weight value group after the division has sparsity higher than or equal to a predetermined value.

### (Supplementary Note 11)

The neural network model conversion method according to supplementary note 10,
wherein, the computer,
in the division position determination process, determines the division position so that the weight value group before the division is divided in the kernel direction,
in the division process, divides the weight value group before the division at the division position, and
in the connection layer addition process, adds the connection layer that makes the one output data by connecting the respective output data obtained by calculating the input data and the respective weight value groups after the division, in the channel direction.

### (Supplementary Note 12)

The neural network model conversion method according to supplementary note 10,
wherein, the computer,
in the division position determination process, determines the division position so that the weight value group before the division is divided in the channel direction,
in the division process, divides the weight value group before the division at the division position, and
in the connection layer addition process, adds the connection layer that derives the one output data by adding corresponding elements in the respective output data obtained by calculating the input data and the respective weight value groups after the division.

### (Supplementary Note 13)

A computer-readable recording medium in which a neural network model conversion program is recorded, wherein the neural network model conversion program causes a computer to execute:
a division position determination process of determining a division position in a weight value group, which is a weight value group of at least one layer included in a given neural network model, and has a configuration kernels are arranged in a kernel direction, each of which is obtained by arranging at least one or more weight values in a channel direction;
a division process of obtaining multiple weight value groups by dividing the weight value group at the division position; and
a connection layer addition process of adding a connection layer that is a layer that connects respective output data obtained by calculating input data to the layer and respective weight value groups after division to make one output data,
wherein the neural network model conversion program causes the computer to execute, in the division position determination process,
when regarding a ratio of the number of weight values that are 0 to the number of weight values in the weight value group as sparsity, determining the division position in the weight value group before division so that at least one weight value group after the division has sparsity higher than or equal to a predetermined value.

### (Supplementary Note 14)

The computer-readable recording medium in which the neural network model conversion program is recorded, according to supplementary note 13, wherein the neural network model conversion program causes the computer to execute:
in the division position determination process, determining the division position so that the weight value group before the division is divided in the kernel direction,
in the division process, dividing the weight value group before the division at the division position, and
in the connection layer addition process, adding the connection layer that makes the one output data by connecting the respective output data obtained by calculating the input data and the respective weight value groups after the division, in the channel direction.

### (Supplementary Note 15)

The computer-readable recording medium in which the neural network model conversion program is recorded, according to supplementary note 13, wherein the neural network model conversion program causes the computer to execute:
in the division position determination process, determining the division position so that the weight value group before the division is divided in the channel direction,
in the division process, dividing the weight value group before the division at the division position, and
in the connection layer addition process, adding the connection layer that derives the one output data by adding corresponding elements in the respective output data obtained by calculating the input data and the respective weight value groups after the division.

Although the present invention has been described above with reference to the example embodiments, the present invention is not limited to the above example embodiments. Various changes can be made to the configuration and details of the present invention that can be understood by those skilled in the art within the scope of the present invention.

### INDUSTRIAL APPLICABILITY

The present invention is suitable for neural network model conversion devices that convert neural network models.

### REFERENCE SIGNS LIST

10, 20, 30, 40, 50, 60 Neural network model conversion device
11 Division position determination unit
12 Division unit
13 Connection layer addition unit
21 Kernel sorting unit
22 Output data sorting layer addition unit
31 Next layer sorting unit
41 Division position determination unit
42 Division unit
43 Connection layer addition unit
51 Channel sorting unit
52 Input data sorting layer addition unit
61 Previous layer sorting unit

What is claimed is:

1. A neural network model conversion device comprising:
a memory configured to store instructions;
a processor configured to execute the instructions to:
determine a division position in a weight value group, which is a weight value group of at least one layer included in a given neural network model, and has a configuration kernels are arranged in a kernel direction, each of which is obtained by arranging at least one or more weight values in a channel direction;
obtain multiple weight value groups by dividing the weight value group at the division position; and
add a connection layer that is a layer that connects respective output data obtained by calculating input data to the layer and respective weight value groups after division to make one output data,
wherein the processor,
when regarding a ratio of the number of weight values that are 0 to the number of weight values in the weight value group as sparsity, determines the division position in the weight value group before division so that at least one weight value group after the division has sparsity higher than or equal to a predetermined value.

2. The neural network model conversion device according to claim 1,
wherein the processor determines the division position so that the weight value group before the division is divided in the kernel direction,
the processor divides the weight value group before the division at the division position, and
the processor adds the connection layer that makes the one output data by connecting the respective output data obtained by calculating the input data and the respective weight value groups after the division, in the channel direction.

3. The neural network model conversion device according to claim 1, wherein
the processor sorts the kernels included in the weight value group before the division, according to a predetermined criterion,
wherein the processor determines the division position so that the weight value group after kernel sorting is divided in the kernel direction,
the processor divides the weight value group before the division at the division position, and
the processor adds the connection layer that makes the one output data by connecting the respective output data obtained by calculating the input data and the respective weight value groups after the division, in the channel direction, and
wherein the processor adds an output data sorting layer that sorts channels of the one output data to correspond to order of the kernels in the weight value group before kernel sorting, based on change in order of the kernels due to sorting by the processor.

4. The neural network model conversion device according to claim 1, wherein
the processor sorts the kernels included in the weight value group before the division, according to a predetermined criterion; and
the processor sorts channels of next layer of the layer whose weight value group is divided according to order of the kernels sorted by the processor,
wherein the processor determines the division position so that the weight value group after kernel sorting is divided in the kernel direction,
the processor divides the weight value group before the division at the division position, and
the processor adds the connection layer that makes the one output data by connecting the respective output data obtained by calculating the input data and the respective weight value groups after the division, in the channel direction.

5. The neural network model conversion device according to claim 3,
wherein the processor sorts the kernels included in the weight value group before the division, in descending or ascending order of the number of weight values that are 0.

6. The neural network model conversion device according to claim 1,
wherein the processor determines the division position so that the weight value group before the division is divided in the channel direction,
the processor divides the weight value group before the division at the division position, and
the processor adds the connection layer that derives the one output data by adding corresponding elements in the respective output data obtained by calculating the input data and the respective weight value groups after the division.

7. The neural network model conversion device according to claim 1, wherein
the processor sorts the channels included in the weight value group before the division, according to a predetermined criterion; and
the processor adds an input data sorting layer that sorts channels of the input data according to order of the channels sorted by the processor,
wherein the processor determines the division position so that the weight value group after channel sorting is divided in the channel direction,
the processor divides the weight value group before the division at the division position, and
the processor adds the connection layer that derives the one output data by adding corresponding elements in the respective output data obtained by calculating the input data and the respective weight value groups after the division.

8. The neural network model conversion device according to claim 1, wherein
the processor sorts the channels included in the weight value group before the division, according to a predetermined criterion; and
the processor sorts kernels of weight value group of previous layer of the layer whose weight value group is divided according to order of the channels sorted by the processor,
wherein the processor determines the division position so that the weight value group after channel sorting is divided in the channel direction,
the processor divides the weight value group before the division at the division position, and
the processor adds the connection layer that derives the one output data by adding corresponding elements in the respective output data obtained by calculating the input data and the respective weight value groups after the division.

9. The neural network model conversion device according to claim 7,
wherein the processor sorts the channels included in the weight value group before the division, in descending or ascending order of the number of weight values that are 0.

10. A neural network model conversion method, implemented by a computer, comprising:
a division position determination process of determining a division position in a weight value group, which is a weight value group of at least one layer included in a given neural network model, and has a configuration kernels are arranged in a kernel direction, each of which is obtained by arranging at least one or more weight values in a channel direction;
a division process of obtaining multiple weight value groups by dividing the weight value group at the division position; and
a connection layer addition process of adding a connection layer that is a layer that connects respective output data obtained by calculating input data to the layer and respective weight value groups after division to make one output data,
wherein, in the division position determination process,
when regarding a ratio of the number of weight values that are 0 to the number of weight values in the weight value group as sparsity, the computer determines the division position in the weight value group before division so that at least one weight value group after the division has sparsity higher than or equal to a predetermined value.

11. The neural network model conversion method according to claim 10,
wherein, the computer,
in the division position determination process, determines the division position so that the weight value group before the division is divided in the kernel direction,
in the division process, divides the weight value group before the division at the division position, and
in the connection layer addition process, adds the connection layer that makes the one output data by connecting the respective output data obtained by calculating the input data and the respective weight value groups after the division, in the channel direction.

12. The neural network model conversion method according to claim 10,
wherein, the computer,
in the division position determination process, determines the division position so that the weight value group before the division is divided in the channel direction,
in the division process, divides the weight value group before the division at the division position, and
in the connection layer addition process, adds the connection layer that derives the one output data by adding corresponding elements in the respective output data obtained by calculating the input data and the respective weight value groups after the division.

13. A non-transitory computer-readable recording medium in which a neural network model conversion program is recorded, wherein the neural network model conversion program causes a computer to execute:
a division position determination process of determining a division position in a weight value group, which is a weight value group of at least one layer included in a given neural network model, and has a configuration kernels are arranged in a kernel direction, each of which is obtained by arranging at least one or more weight values in a channel direction;
a division process of obtaining multiple weight value groups by dividing the weight value group at the division position; and
a connection layer addition process of adding a connection layer that is a layer that connects respective output data obtained by calculating input data to the layer and respective weight value groups after division to make one output data,
wherein the neural network model conversion program causes the computer to execute, in the division position determination process,
when regarding a ratio of the number of weight values that are 0 to the number of weight values in the weight value group as sparsity, determining the division position in the weight value group before division so that at least one weight value group after the division has sparsity higher than or equal to a predetermined value.

14. The non-transitory computer-readable recording medium in which the neural network model conversion program is recorded, according to claim 13, wherein the neural network model conversion program causes the computer to execute:
in the division position determination process, determining the division position so that the weight value group before the division is divided in the kernel direction,
in the division process, dividing the weight value group before the division at the division position, and
in the connection layer addition process, adding the connection layer that makes the one output data by connecting the respective output data obtained by calculating the input data and the respective weight value groups after the division, in the channel direction.

15. The non-transitory computer-readable recording medium in which the neural network model conversion program is recorded, according to claim 13, wherein the neural network model conversion program causes the computer to execute:
in the division position determination process, determining the division position so that the weight value group before the division is divided in the channel direction,
in the division process, dividing the weight value group before the division at the division position, and
in the connection layer addition process, adding the connection layer that derives the one output data by adding corresponding elements in the respective output data obtained by calculating the input data and the respective weight value groups after the division.
